(19) United States
(12) Patent Application Publication
(10) Pub. No.: US 2013/0299748 A1
(43) Pub. Date: Nov. 14, 2013

(54) SYNTHESIS OF HIGH SPECIFIC CAPACITANCE POROUS CARBON POWDERS FOR USE IN DOUBLE ELECTRIC LAYER ELECTROCHEMICAL CAPACITORS

(71) Applicants: Samvel Kazaryan, Troitsk (RU); Gamir Kharisov, Troitsk (RU); Sergey Litvinenko, Zelenograd (RU); Vyacheslav I. Shumovsky, Zelenograd (RU)

(72) Inventors: Samvel Kazaryan, Troitsk (RU); Gamir Kharisov, Troitsk (RU); Sergey Litvinenko, Zelenograd (RU); Vyacheslav I. Shumovsky, Zelenograd (RU)

(73) Assignee: UNIVERSAL SUPERCAPACITORS LLC, Columbus, OH (US)

(21) Appl. No.: 13/469,530

(22) Filed: May 11, 2012

(51) Int. Cl. C01B 31/08; C01B 31/12; H01B 1/04; C01B 31/10

(52) U.S. Cl. 252/502; 423/460

(57) ABSTRACT

The present invention relates to the field of the synthesis of porous carbon materials and their use in the manufacture of electrodes with a double electric layer (DEL) for electrochemical capacitors having an aqueous and organic electrolyte having high specific energy parameters. The synthesis technology makes it possible to manufacture porous carbon powders made of carbohydrate substances with a low content of ash and metals in the powders with high specific capacitances and low specific electrical resistances.

### BACKGROUND OF THE INVENTIVE FIELD

This invention relates to the field of synthesis of porous carbon materials and may be effectively used in the manufacture of electrodes for electrochemical capacitors with a double electric layer (DEL) and having an aqueous and organic electrolyte and high specific energy parameters.

The proposed synthesis technology makes it possible to manufacture porous carbon powders made of carbohydrate substances with a low content of ash and metals in the powders, which bring about a shuttle self-discharge of an associated electrochemical capacitor with high specific capacitances and low specific electrical resistances.

This invention may also be used, for example, in manufacture of filters for purification of potable water, liquid and gaseous substances of food industry, contaminated effluents, exhaust gasses of industrial and utility facilities, hemosorbents for blood depuration, enterosorbents to eliminate microbes in the body, heavy metals and hazardous substances.

Currently, different porous carbon materials have been extensively used in the fields of electrical engineering, food industry, medicine, power engineering and ecology due to their unique properties. Many fundamental parameters of porous carbon materials may vary in a wide range based on the synthesis technology and properties of the source material used. When porous carbon materials are used for manufacture of electrodes of electrochemical capacitors with a DEL, the following parameters are important: specific capacitance of the DEL, conductivity of the pore walls, sizes and shapes of pores, distribution of pores by sizes, and chemical composition of the materials.

For a use of porous carbon materials in such fields as medicine, purification of potable water and the food industry, the following parameters are most important: chemical composition, sizes of pores, distribution of pores by sizes and specific surface area. In the purification of contaminated effluents and exhaust gasses of industrial and utility facilities, low contents of different impurities in porous carbon materials play a less important role. The list and contents of impurity atoms are substantially limited for the manufacture of electrochemical capacitors and use in the fields of medicine, potable water purification and food industry. Therefore, the requirements of porous carbon materials are determined by each particular application.

Currently, porous carbon materials are widely used for the manufacture of electrodes of different electrochemical capacitors with a DEL. Different synthesis technologies of various porous carbon materials have been developed for the manufacture of electrochemical capacitors. Various parameters of electrochemical capacitors such as specific energy, specific capacitance, specific power and self-discharge current are directly related to the main properties and parameters of porous carbon materials. The capacitance of the DEL, which is formed in the interface of the electrolyte and porous carbon material, is closely related to the sizes and forms of the pores, thicknesses and conductivity of the pore walls, structural defects of crystalline lattice and dimensions of crystals of the carbon particles.

The pores of the carbon materials are usually grouped by sizes into micropores (<2 nm size), mesopores (sizes in the range of about 2 nm-50 nm) and macropores (>50 nm size). In many porous carbon materials, the specific surface area may reach 3,000 m²/g. Furthermore, in most carbon materials with high specific area, the specific capacitance does not exceed 300 F/g, which limits the manufacture of electrochemical capacitors with high specific energy and capacity parameters. However, many theoretical calculations show that the currently achieved level of the energy, capacity and operation parameters of the best samples of the advanced electrochemical capacitors using porous carbon materials is not limited by the capabilities of the carbon materials.

With a view of increasing the specific capacity parameters of porous carbon materials, different synthesis technologies have been developed. These technologies have made it possible (by using new technological solutions, carbonaceous raw material, better auxiliary technological materials, etc.) to synthesize carbon powders with specific capacitances suitable for a practical use in electrochemical capacitors. Porous carbon materials are mostly synthesized from different carbonaceous substances, but organic substances are the most manufacturable raw materials. Many organic substances provide for a high carbon output and are carbonized at low temperatures. Furthermore, the process of carbonization is easily controlled. Often, in order to control the parameters of the porous carbon materials for electrochemical capacitors, use is made of such well-known methods as measurements of specific surface area, specific capacitance, distribution of pores by sizes (see e.g., US 2005/0207962) or measurements of optical spectrums in the area of the oscillation frequencies of the carbon atoms of the crystal lattice (see e.g., U.S. Pat. No. 6,589,904).

The carbon electrodes with a DEL based on porous carbon powders synthesized from saccharose in the presence of zinc chloride and additionally activated in KOH melt, with an organic electrolyte, have specific capacitance of not more than 40 F/g (see Synthetic Metals 135-136 (2003) 235-236). In U.S. Pat. No. 6,589,904, which proposes the manufacture of different carbon materials with the use of different methods of activation and thermal treatment, it was established that the specific capacitance of the best samples of carbon electrodes, being components of a symmetric electrochemical capacitor with an organic electrolyte, also does not exceed 40 F/g. The specific capacitance of the best samples of porous carbon materials obtained by traditional methods is usually in the range of 80-120 F/g in aqueous electrolytes, and in organic electrolytes, 25-40 F/g.

Currently, the best known result in terms of specific capacitance is obtained as disclosed in US 2005/0207962, in which it was established that the maximum specific capacitance of porous carbon materials in aqueous electrolytes may reach 296 F/g, and in organic electrolytes, 58-121 F/g, subject to the specific surface area of the powders and modes of their synthesis technology. According to US 2005/0207962, in order to synthesize porous carbon materials, use is made of a carbohydrate raw material. At the initial stage of the synthesis, carbohydrates are dehydrated and carbonized. Further, at the final stage of the synthesis, the obtained carbon material is subjected to high-temperature carbonization. With a view of forming a porous structure, use is made of different non-metal cationic components, which are added to the source raw material and are, in fact, fully decomposed to volatile products during thermal treatment. Decomposition and evaporation of the said compounds result in the formation of pores having different sizes. The synthesis technology of porous carbon materials makes it possible to perform activation of the carbon materials by different reagents such as carbon dioxide, water vapor, potassium hydroxide, which are traditional reagents and are usually used for carbon materials' activation. The distinctiveness of the technology lies in the fact that the average pore size of the carbon materials is in the range of 2-50 nm and the pore volume distribution curve, subject to the pore size, has two peaks in the areas of the pore sizes, the peaks occurring at 0.5-1.0 nm and 1.0-5.0 nm.

Despite the fact that the obtained values of the specific surface area of porous carbon materials made per the technology of US 2005/0207962 have quite high values (up to 2,758 m²/g), the values of the specific capacitances of the materials are very much inferior to the theoretically expected value. The low values of the specific capacitances of porous carbon materials are related to the fact that, firstly, the teachings of US 2005/0207962 are premised on the belief that the capacitance of porous carbon materials grows linearly along with the growth of the area of the specific surface and the low value of the specific capacitance is determined by the low accessibility of the electrolyte to the surfaces of micropores. It is also believed that in order to increase access of the electrolyte to the pore surfaces it is necessary to ensure that the carbon powders are mesoporous (i.e., the carbon powders with high values of specific capacitance should mostly have mesopores).

Secondly, despite high specific power parameters of electrochemical capacitors with electrodes based on mesoporous carbon materials, the capacitors with the electrodes have very low specific energy. This is mostly related to the low values of the specific area of mesoporous carbon materials. For example, when the average size of mesopores is 5 nm, the specific surface area of mesoporous carbon materials does not exceed 600 m²/g which, undoubtedly, results in low values of specific capacitance. Therefore, one of the drawbacks of the methods proposed in US 2005/0207962 for manufacture of mesoporous carbon materials is the fact that the methods are directed at obtaining mesoporous carbon materials, which results in low values of their specific capacitance.

According to the present invention, the specific capacitance of the porous carbon materials, apart from the specific surface area, depends on the conductivity of the pore walls, density of surface states of the pore walls and crystallographic parameters of crystals of the materials' particles. The highest values of the specific capacitance may be obtained in microporous carbon materials—the walls of the pores have high conductivity and high density of surface states.

The porous carbon materials are usually not pure substances, and contain many impurity atoms, most of which have a considerable negative effect on the parameters of electrochemical capacitors. The quantity of different impurity atoms in the porous carbon materials varies from several ppm to several percent. Many impurity atoms are contained in the source materials from which carbon materials are synthesized, and are also partially introduced in the carbon materials during their synthesis. For example, the presence of Fe, Mn, Cr, Ti, Cu and other transition metals results in shuttle self-discharge of the capacitors and decrease of overpotentials of evolution of their electrodes' hydrogen and oxygen. As a result, the following important parameters of electrochemical capacitors deteriorate substantially: specific energy, self-discharge, cycle life, stability of energy and capacity parameters. Apart from these drawbacks, the use of carbon materials with high content of transition metals in the capacitors results in an increase of the cost of the stored energy. The high cost of the stored energy and low specific energy parameters are currently the main causes that limit commercial production of electrochemical capacitors for their wide application.

In most carbonaceous organic substances the mass of carbon does not, in fact, exceed 44% of the dry substance's weight. After the carbonization and activation of the organic substances, the mass of the obtained porous carbon materials is no more than 15-20% of the mass of the dry source material, subject to the specific surface area of the powders. That is, the mass of the porous carbon materials is approximately 5-7 times lower than the mass of the dry source organic substance. Consequently, while the organic substance contains impurities of certain elements, the content of these impurities in porous carbon materials increases approximately 5-7 times. The utilized auxiliary technological reagents, which, during the synthesis of the carbon materials, have a direct contact with the source substance and carbon material, also increase the content of impurities in the carbon materials.

The rate of increase of impurity atoms in the porous carbon materials is considerably higher when used in the synthesis technology of auxiliary materials, which are in direct contact with the source substance or carbon material and are partially or fully decomposed during the synthesis. Since, in the technology, described in US 2005/0207962, use is made of different non-metal cationic components which are fully decomposed, it is obvious that the impurities contained in the cationic components will pass over to the composition of carbon materials. Taking into account that the mass ratio of cationic components and carbon of the source substance has a quite high value, it is apparent that for synthesis of clean carbon materials it is necessary to use components with high cleanliness. The use of highly-clean reagents results in an increase of the price parameter of the porous carbon materials.

For synthesis of porous carbon materials with a low content of impurities and low cost, it is preferable to use cleaner source organic substances and auxiliary technological materials. According to the present invention, a good variant to clean carbon materials is the use of reagents in which a considerable part of impurity atoms contained in the source organic substances is dissolved. Secondly, it is preferable to minimize the list and quantity of auxiliary technological materials, and not to use auxiliary substances which are decomposed during the synthesis. In order to decrease the price parameter of the porous auxiliary materials, it is preferable to use such auxiliary technological materials which are subjected to regeneration for reutilization.

Usually, the particles of the porous carbon materials during their synthesis have large linear dimensions, as it is shown in US 2005/0207962. The use of such particles during the manufacture of electrodes for electrochemical capacitors or filters is non-manufacturable and requires an additional procedure of grinding. This makes the synthesis technology more complex and the porous carbon powders more costly.

### SUMMARY OF THE GENERAL INVENTIVE CONCEPT

This invention discloses a method of synthesis of microporous conductive carbon materials. Porous carbon materials are synthesized from different types of carbohydrate organic phytogenous substances with a low content of metal impurities and ash. In the preferred embodiment, at least one substance from the group of monosaccharides, disaccharides, polysaccharides or their mixtures with different combinations, and with different mass ratios of components, is used as the organic carbohydrate substance.

The method of synthesis is comprised of a process of preliminarily initiated carbonization of organic substances performed by dehydrating the substances under normal conditions in the presence of the conductive carbon particles. Finely-dispersed conductive carbon particles are seeds of the growth of the carbon materials' crystals and initiate the process of preliminary carbonization of organic substances. The use of seeds with the assigned crystallographic, physical, electrochemical and electrical parameters makes it possible to control the parameters of the porous carbon materials. This feature of the proposed method makes it possible to synthesize porous carbon powders with the assigned and high values of specific capacitance.

After the process of the preliminarily initiated carbonization of organic substances under normal conditions, the initiated carbonization continues at elevated temperatures (preferably in the range of about 120-180° C.). Further, to obtain porous carbon materials, the process of interim carbonization is preferably performed at elevated temperatures (preferably in the range of about 250-350° C.) and the process of the final carbonization and activation of the carbon powders preferably occurs at a temperature range of about 600-1,000° C. The formation of pores is performed by means of chemical activation, gas-vapor activation, or a combination of consequential processes of chemical and gas-vapor activation of carbon powders.

The process of chemical activation is performed in parallel with the process of final carbonization or after the final carbonization of carbon materials. The process of gas-vapor activation is preferably performed after the final carbonization of carbon materials. The proposed method of synthesis makes it possible to obtain porous carbon powders without the grinding of carbon materials. The size of the powder particles is controlled by controlling the rate of preliminary carbonization at room and elevated temperatures.

According to this invention, the value of DEL capacitance of porous carbon materials depends significantly on the conductivity, density of surface states of the pore walls and crystallographic parameters of crystals of the carbon material particles. The high values of specific capacitance are obtained due to microporous structure, high conductivity and high density of surface states of the walls of the carbon material pores. This method of synthesis makes it possible to effectively dope the porous carbon materials by impurity atoms which improve their capacity parameters. In particular, the doping by Boron atoms results in a growth of the specific capacitance of the DEL and conductivity of porous carbon materials.

For the purposes of synthesis of clean porous carbon materials, use is made of carbohydrate substances which have molecular formulas C₆H₁₂O₆, C₁₂H₂₂O₁₁ and (C₆H₁₀O₅)ₙ, where n is a whole number in the range of 2-15000. The use of carbohydrate substances, which are fully or partially dissolved or at least swelled in water, is preferable. In the preferred embodiment, the mass content of iron and manganese in dry carbohydrate substances should not exceed 100 ppm and 200 ppm respectively, and the ash content, 1.5%.

In the preferred embodiment, this invention relates to the synthesis of microporous carbon powders and manufacture of carbon electrodes on the basis of the above-mentioned microporous carbon powders. The porous carbon powders are characterized by specific electric resistance whose value does not exceed 20 Ohm·cm (at 475 kg/cm² pressure) and the maximum specific capacitance whose value is in the range of 600-1,400 F/g (in an aqueous sulfuric acid electrolyte).

Some of the objectives of this invention include:
a. Development of a less expensive method for the synthesis of porous carbon materials with a low content of metal impurities for their wide use in different areas of engineering, industry, power engineering, medicine and ecology; and
b. Development of a synthesis technology of microporous carbon powders with controlled parameters and high values of specific capacitances and specific conductivities.

The use of porous carbon powders synthesized as per the proposed method, for the manufacture of electrodes of commercial DEL electrochemical capacitors, shall provide for high specific energy, capacity and power parameters, low self-discharge and low cost. The main parameters of porous carbon materials is easily controlled in a wide range, which makes it possible to synthesize carbon powders with pre-assigned parameters for electrochemical capacitors designed for different purposes.

The essence of the proposed method of synthesis of porous carbon materials with high values of specific capacitance and conductivity is explained by the following detailed description of physical processes of the formation of capacitance of DEL and its dependence on the potential, conductivity, concentration of dopants and lattice defects. The disclosure also includes a description of the synthesis technology of porous carbon powders, specific examples of synthesis and testing of energy, capacity and electrical parameters of porous carbon powders and the following figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1. illustrates an energy diagram of an electrolyte-pore wall interface;

FIG. 2. illustrates defects of “zigzag edge”, “armchair edge”, and “bearded edge” types and vacancy of graphen plane of a finite size;

FIG. 3. illustrates the preferred process flow sheet for the synthesis of porous carbon powders;

FIG. 4. illustrates one design of a device to measure specific resistance of carbon powders;

FIG. 5. illustrates one design of a DEL electrochemical capacitor of a PbO₂|H₂SO₄|C system with a negative electrode based on carbon powder;

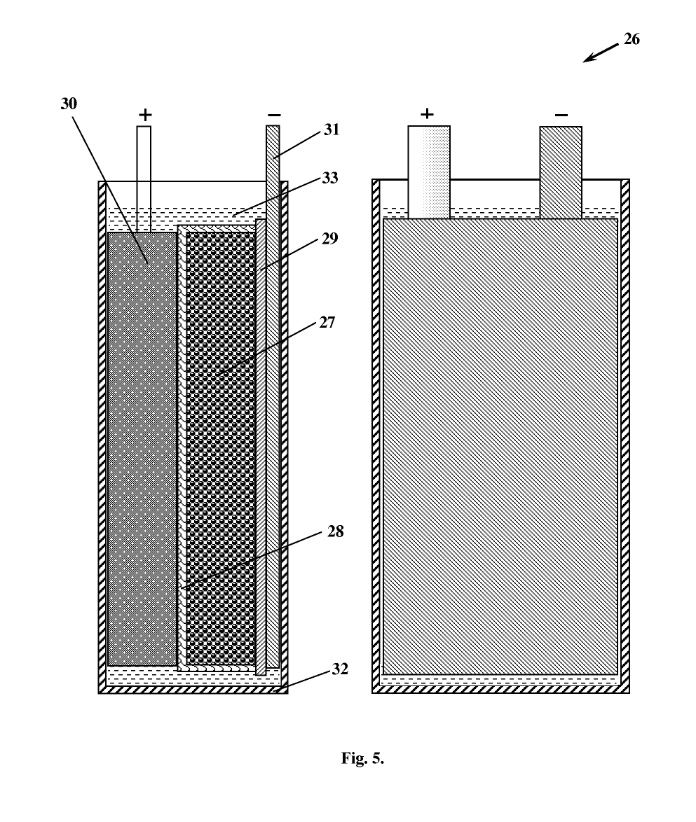

FIG. 6. illustrates the dependences of specific electrical resistances of porous carbon powders on external pressure;

FIG. 7. illustrates the time dependences of potentials (in relation to the potential of PbO₂/PbSO₄ reference electrode) of the negative electrodes of HESs with active material made of different porous carbon powders during the charge (a) and discharge (b) of the capacitors;

FIG. 8. illustrates the dependencies of |Z| impedance on voltage using several exemplary heterogeneous electrochemical supercapacitors (HES′) with negative electrodes made of carbon powders, during 5-hour charge and 5-hour discharge of the capacitors;

FIG. 9. illustrates the time dependence of potential (in relation to potential of PbO₂/PbSO₄ reference electrode) of the negative electrode of an exemplary HES, during charge (a) and discharge (b) by 100 mA constant current with the duration of charge: 2 hours (1); 4 hours (2); 6 hours (3); 8 hours (4); 10 hours (5); 12 hours (6);

FIG. 10. illustrates the design of electrochemical capacitor with DEL of PbO₂|H₂SO₄|C system, with negative electrode based on carbon plate.

FIG. 11. illustrates the time dependence of potential (in relation to PbO₂/PbSO₄ reference electrode) of a negative electrode of an exemplary HES during charge (a) and discharge (b) by 400 mA current with the duration of charge being: 0.5 hour (1); 1 hour (2); 2 hours (3); 4 hours (4); 6 hours (5); 8 hours (6); 10 hours (7); 12 hours (8);

FIG. 12. illustrates the dependence of capacitance of the negative electrode of an exemplary HES on potential (in relation to potential of a PbO₂/PbSO₄ reference electrode);

FIG. 13 is a table listing the mass parameters of components during synthesis of exemplary porous carbon powders made of different carbohydrate substances; and

FIG. 14 is a table listing the specific capacity, energy parameters and specific resistances of various exemplary porous carbon powders.

### DETAILED DESCRIPTION OF EXEMPLARY EMBODIMENT(S)

Currently, different technologies of synthesis of various porous carbon materials have been developed. Unlike graphite, the porous carbon materials have a free porous space, which usually has the structure of a three-dimensional labyrinth of interconnected enlargements and narrowings of different sizes and shapes. The walls of the pores represent a matrix arranged in a way similar to the structure of graphite—i.e., the pore walls are formed from the parallel layers of a flat hexagonal lattice (graphen) of a finite size. Since the graphen with infinite sizes and without structural defects is a semi-conductor with a very narrow band gap or, as it is often considered, a semimetal, the walls of the pores of porous carbon material along the graphen planes have a semimetal pattern, and in the direction perpendicular to the planes of the graphen, a strongly pronounced semi-conductor pattern. It is known that in the case of a decrease of the graphen sizes and/or formation of lattice defects, when bonds are broken between the nearest carbon atoms, the width of the graphen's band gap grows along with a decrease of their sizes (see e.g., International Scientific Journal for Alternative Energy and Ecology #6(26), 75-77 (2005)) and a growth of concentration of defects (see e.g., Physics and technique of semi-conductors, volume 38, issue 6, pp. 641-664 (2004)). During the synthesis of porous carbon materials, the graphens in the pore walls have small linear dimensions (they contain a great number of lattice defects and peripheral atoms, which have dangling bonds), and the pore walls in all the directions have a semi-conductor pattern. The semi-conductor properties of the pore walls depend on the sizes, symmetry of pores and specific surface area of the porous carbon materials.

Many lattice defects in the pore walls, different surface states on the wall surfaces, as well as the formed dangling bonds of the interfaces between graphite crystals of particles of porous carbon materials, brings about formation of mostly p-type conductivity of the pore walls. The Fermi level shifts deep inside the valence band and the value of the shift depends on the concentration and types of the defects. Many parameters depend considerably on the position of the Fermi level, including the parameters which are important for the manufacture of the electrodes of electrochemical capacitors and porous carbon materials. Therefore, unlike different applications of porous carbon materials, in which an important role is played by such parameters as specific surface area, specific volume of pores and distribution of pores by sizes—when they are used for the manufacture of electrodes of DEL electrochemical capacitors, the conductivity, density of surface states, crystallographic and electrochemical parameters are also important.

The structure of the electrolyte-pore wall interface and capacitance of the interface depend on the properties of the electrolyte and the pore wall. The electric charge from the side of different metal electrodes is localized in the thin near-surface layers thereof due to the high concentration of free electrons in metals. The thickness of the layer in which non-equilibrium charge carriers are localized does not exceed 0.05-0.2 nm, subject to the type of metal, and in a wide range does not depend on the value of the potential of the metals' surface. A quite different situation is with the walls of the pores of the porous carbon materials. Here, the concentration of free charge carriers is 10³-10⁴ lower than in metals. Therefore, the electric charge from the side of the walls of the pores of conductive carbon materials spreads deep inside the near-surface layer whose thickness is considerably greater than the thickness of a similar layer of metals. Secondly, the concentration of free charge carriers in carbon materials, unlike metals, depends considerably on the technology of their synthesis, on the Fermi level's position and along with a change of the surface's potential changes in a wide range.

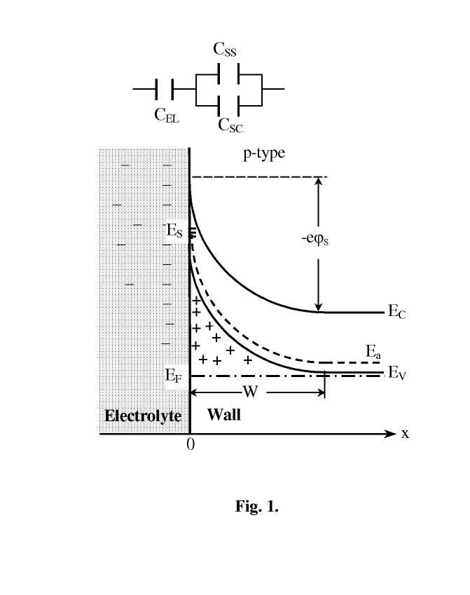

For the purpose of considering the dependence of conductivity of the pore walls and capacitance of the porous carbon materials on the potential, density of surface states and other parameters during the charge and discharge of electrochemical capacitors, FIG. 1 shows the energy diagram of the electrolyte-pore wall interface of a porous carbon material with p-type conductivity. Assuming that the surface of the pore wall at the value of x=0 is in contact with the electrolyte. When there is a shift of the potential of the surface of the pore wall (φ_{S}), in relation to the potential of the zero charge (φ_{PZC}), a shift takes place of all the levels, including the discrete ones, which lie in the band gap. However, if the wall is in the state of thermodynamic equilibrium, the Fermi level in the wall is constant, consequently, the energy distances between the Fermi level and the valence band, conductivity band and discrete levels change. This results in the dependence of the potential of the wall along its thickness (d_{wall}) as it is shown FIG. 1. Let the thickness d_{wall} be such that at high values of φ_{S}, the condition φ(x=d_{wall}/2)=φ_{PZC} is satisfied, where φ(x) is the potential of the pore wall.

If the surface potential φ_{S}=0, the energy bands of the wall are flat, and in the case of a shift of φ_{S} to the negative area, when the electrolyte's negative ions are accumulated on the wall's surface from the electrolyte's side, the energy bands of the wall bend upward as it is shown in FIG. 1. In the case of a shift of φ_{S} to the positive area of the potentials, when the electrolyte's positive ions are accumulated on the surface of the pore wall from the electrolyte's side, the energy bands of the wall bend downwards. Accordingly, when there is a bend of the zones in the near-surface layer of the pore wall, there emerges a space charge region (SCR) with W thickness. SCR thickness of the pore wall depends on φ_{S} value and the wall's properties, is a dynamic value and changes during the charge and discharge of electrochemical capacitors. Apart from SCR thickness, along with a change of φ_{S} potential, there is a change of the concentration of free electrons and holes. When there is a change of φ_{S} potential, the concentration of holes, electrons, as well as the value of conductivity of the pore wall, change along the thickness of the wall. The non-equilibrium concentrations of holes p(x) in the walls of the pore of a porous carbon material with degenerated hole gas and non-degenerated electronic gas are expressed by the formula:

$$p ( x ) = \frac{{\{ 2 {m}_{h} [ {ξ}_{F} + e ϕ ( x ) ] \}}^{3 \text{/} 2}}{3 {π}^{2} {ℏ}^{3}} , \qquad ( 1 )$$

and of electrons n(x) by the formula:

$$n ( x ) = 2 {( \frac{{m}_{e} kT}{2 {πℏ}^{2}} )}^{3 \text{/} 2} exp ( \frac{{E}_{F} - {E}_{C} - e ϕ ( x )}{kT} ) . \qquad ( 2 )$$

where: ξ_{F}=E_{V}−E_{F} (E_{V}—energy of the valence band top, E_{F}—energy of the Fermi level); E_{C}—energy of the conductivity band bottom; mₕ—effective mass of holes, and mₑ—of electrons. The conductivity of the pore walls σ(x) is expressed by the formula:

σ(x)=e[μₚp(x)+μₙn(x)], (3)

where: μₙ and μₚ—mobilities of electrons and holes respectively.

Therefore, it follows from the formulas (1), (2) and (3) that the concentration of free charge carriers and conductivity of the walls of the pores of porous carbon materials change along the thicknesses of the walls during the charge and discharge of the capacitors. Acceptor centers and surface states of the walls of the pores with p-type conductivity have a significant effect on p(x), n(x) and σ(x) parameters. The acceptor centers in the band gap of the wall creates acceptor levels (Eₐ) along the entire thickness of the wall, and the surface state creates a set of energy levels (E_{S}) on the surfaces of the pore walls (FIG. 1). The change of φ_{S} potential will result in the filling or exhaust of Eₐ and E_{S} levels and, accordingly, the volume charge and conductivity in SCR of the pore walls change during the charge and discharge of an electrochemical capacitor. In the case of a strong shift of φ_{S} to the area of positive values in SCR from the side of the electrolyte, there occurs a change of the type of conductivity of the pore wall. A change of the type of conductivity of the pore walls in porous carbon materials with p-type conductivity depends mostly on the value of the equilibrium concentration of holes and value of the polarization's potential. The effect is often observed in the electrodes of electrochemical capacitors on the basis of carbon materials with equilibrium concentration of holes not more than 10¹⁹ cm⁻³ and with an aqueous electrolyte. Experiments show that in this case DEL capacitance of the electrodes decreases and there occurs a growth of their resistance.

The emergence of SCR in the near surface layers of the pore wall brings about formation of the capacitance (C_{SC}). The charged surface states form the capacitance on the wall's surfaces C_{SS}. Furthermore, the capacitances C_{SC} and C_{SS} are combined in parallel and the aggregate capacitance of the pore walls (C_{W}) of the porous carbon materials shall be as follows:

C_{W}=C_{SS}+C_{SC}. (4)

Consequently, the capacitance (C_{DEL}) of “electrolyte-pore wall” interface represents a sum of the two serially connected capacitances (from the side of the electrolyte (C_{EL}) and from the side of the pore walls) and is expressed by the formula as follows:

$$\frac{1}{{C}_{DEL}} = \frac{1}{{C}_{EL}} + \frac{1}{{C}_{W}} = \frac{1}{{C}_{EL}} + \frac{1}{{C}_{SS} + {C}_{SC}} . \qquad ( 5 )$$

Along with a decrease of the value W, the value of C_{SC} capacitance grows and the value W decreases along with a growth of the concentration of the main charge carriers of the pore walls and increases along with an increase of the absolute values of |φ_{S}| potential. The value C_{SS} depends on the density of the surface states which have energy levels in the band gap of the wall and changes along with a change of |φ_{S}| potential. Consequently, along with a change of φ_{S} potential, the values of C_{SS} and C_{SC} capacitances change, and, as it follows from the formula (5), DEL capacitance is a function of φ_{S} potential, i.e. C_{DEL}=C_{DEL}(φ_{S}), which will be experimentally shown in the examples of this invention.

The density of the surface states grows along with a growth of the specific surface area, the concentrations of the intrinsic lattice defects and along with a decrease of the dimensions of crystals of the carbon materials. It follows from this that in order to increase specific DEL capacitance of the carbon materials, it is sufficient to increase their specific surface (S). However, as it is shown by the authors of PCT application WO 2008067337 A2 “Electrodes With Double Electric Layer of Electrochemical Capacitors With High Specific Parameters”, an increase of S parameter of porous carbon materials brings about a decrease of the thicknesses of the pore walls. When the wall's thickness d_{wall}≦2L_{D}, where: L_{D}—length of Debay screening

$${L}_{D} = \sqrt{\frac{{ɛɛ}_{0} kT}{{e}^{2} p}} ; \qquad ( 6 )$$

ε—wall's permittivity (for the graphite ε=5); ε₀—permittivity of the vacuum (ε₀=8.85·10⁻¹⁴ F/cm); p—equilibrium concentration of holes; W value grows and the screening capability of SCR decreases. This results in a decrease of C_{W} capacitance of the carbon materials and DEL specific capacitance as a whole. It is for this particular reason that many porous carbon materials with 2,500-3,000 m²/g specific surface area have low values of specific capacitance (e.g., US 2005/0207962 A1).

It follows from formulas (5) and (6) that for the synthesis of porous carbon materials with high values of specific capacitance it is preferable to provide for a high value of equilibrium concentration of holes of the pore walls, high density of surface states and optimal specific surface area. Certain specific features of the proposed synthesis technology of porous carbon materials (as it will be shown experimentally below) are as follows: this technology makes it possible to easily control conductivity (equilibrium concentration of holes), specific surface area and density of surface states (thicknesses of pore walls, lattice defects, sizes of particles). Due to these features, the carbon materials synthesized by the proposed method from organic compounds have high values of specific DEL capacitance and conductivity.

It is known that in most solid organic compounds, from which porous carbon materials are usually synthesized, the carbon's atoms are mostly in sp³ state. When thermal carbonization of solid organic raw material is performed, in 400-800° C. interval, a considerable part of the carbon's atoms pass over from sp³ state into sp² state, and a part of the carbon is removed as carbonaceous liquid and gases. During the thermal treatment of organic raw material, graphens having a flat and ordered crystallographic structure are formed in the volume of the solid material. The overall dimensions of graphen planes are considerably related to the conditions of the carbon materials' synthesis. The physical, crystallographic, electrochemical, electrical, optical, magnetic and other properties of porous carbon materials are in many respects determined by the overall dimensions and structural defects of graphen planes. Along with an increase of the temperature of carbonization, microcrystals are formed from the parallel graphen layers, whose dimensions and rate of structural order grow along with a growth of temperature of synthesis and thermal treatment. Along with an increase of temperature of synthesis and thermal treatment, these microcrystals are combined and larger carbon particles are formed.

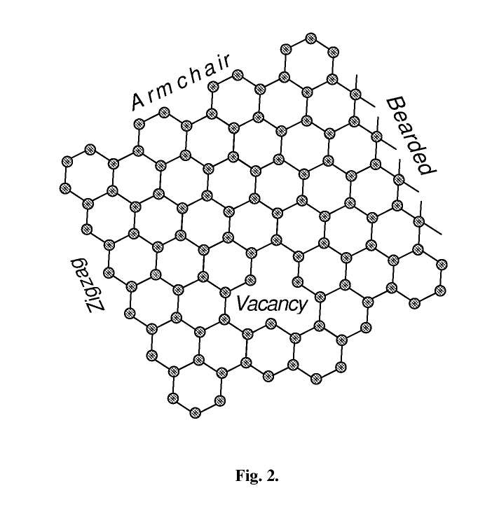

In the walls of the porous carbon materials such lattice defects as “armchair edge”, “zigzag edge” and “bearded edge” defects mostly prevail. These defects are formed on the edges of graphen planes, as it is shown in FIG. 2, and play an important role in the formation of different properties of porous carbon materials. Apart from these defects, a considerable role is also played by such defects as “carbon vacancy” and “carbon interstitial atom” and electrochemical, electrical and physical properties of porous carbon materials depend to a great extent on the concentration of the said defects in the pore walls.

The electronic states of different edges of graphen planes of porous carbon materials defer dramatically. The density of electronic states of graphen with a defect of “zigzag edge” type has sharp peaks at the Fermi level. Such states are absent in the volume graphite. Localized states do not occur in the graphite structures having a lattice defect of graphen planes of “armchair edge” type. However, according to the theoretical calculations, the formation of several beards is quite sufficient to bring about noticeable changes of the electronic structure of graphite. Usually, a defect of “zigzag edge” type is stabilized by one hydrogen atom, and a defect of “bearded edge” type is stabilized by two hydrogen atoms. Since a most noticeable effect on the band structure of graphite is made by the defects of “zigzag edge” type, the capacity parameters of porous carbon materials depend considerably on the density of the surface states of this particular type.

An increase of the density of the surface states of “zigzag edge” defects results in an increase of the density of electric charge on the surface of the walls of the pores of porous carbon material, and accordingly, DEL capacitance of the material grows. Since the electronic states of the defects of “bearded edge” type are stabilized due to the two bonds with hydrogen atoms, this will bring about formation of pseudo capacitance in porous carbon materials in proton solutions. Since the density and types of intrinsic structural defects of crystal lattice in the walls of the pores of porous carbon materials depend on a method of activation of the latter, the method and rate of their activation will have a significant effect on DEL capacitance of carbon materials.

While the edge defects are immobile, the defects of “carbon vacancy” and “carbon interstitial atom” types have high mobility and diffuse mostly in graphen planes, since the barrier for their diffusion through the planes is 4 times higher than in the edge defects. In the transient point, in the course of diffusion from interstitial position to the site position, the carbon's atom has only one C—C bond with the graphen plane, and its hybridization changes by sp. This results in emergence of two free p-orbitals to which an extra electron is transferred, i.e., interstitial carbon atoms bring about an increase of concentration of acceptor centers in the walls of the carbon material's pores. The diffusion of intrinsic lattice defects to the edges of the graphen planes may be captured by the electronic states of the edges which will result in a considerable change of conductivity of the surface of the carbon materials' pores.

The quantity and sizes of the formed pores of the carbon material are determined by the nature of the source raw material, as well as conditions and modes of the process of its thermal treatment. An important aspect, both for control of the process of synthesis of porous carbon materials and for obtaining thereof with pre-set parameters, is the moment of formation of first crystals, as well as the rate and temperature of the raw material's heating. Along with a growth of the rate of heating of the raw material, the total volume of pores, as well as the quantity of micropores, grows considerably. The volume of pores and distribution of pores by sizes is usually quite effectively controlled by changes of the duration and temperature of the process of carbonization of carbon materials.

The structure and properties of porous carbon materials are determined in many aspects by the conditions of the initial stage of the process of their carbonization. When the carbon materials are carbonized, at the temperature of about 350° C. in the absence of oxygen, the so-called thermal black carbon is usually formed with very low porosity and high specific resistance. Apart from the physical, electrical, electrochemical parameters of carbon materials, defects of the lattice and edges of the graphen are also determined by crystallographic parameters of carbon materials during their synthesis. The analysis of the results of different research makes it possible to establish that the parameters of carbon materials synthesized from organic substances by the proposed method depend to a great extent on crystallographic parameters of the initially formed graphen planes and crystals.

According to this invention, after the formation (at the initial stage of synthesis of carbon materials) of first graphens and crystals (nucleuses) they become centers of a catalytic growth. The subsequent growth of sizes of the crystals of the carbon matrix is accompanied by recurrence of the main crystallographic parameters of the nucleuses. If the nucleuses have defective structures, the particles of the synthesized carbon materials also contain similar structural defects. Consequently, it becomes possible to perform synthesis of carbon materials with pre-assigned parameters. In this invention this is done by adding small particles of the carbon materials in the source raw material.

When adding a small amount of carbon material in the source raw material, the carbon's particles initiate the process of the raw material's carbonization and become centers of formation of the carbon's crystals. The initial carbonization of the raw material is preferably performed at lower temperatures than during the carbonization of the raw material in the absence of the initiating carbon powder. By changing the temperature it is possible to easily control the rate of the process of the raw material's preliminary carbonization, which has a significant effect on the crystallographic parameters of the carbon's crystals and on the capacity parameters of porous carbon materials.

Furthermore, in the case of the initiated carbonization of the raw material the main crystallographic, electrical, electrochemical and physical parameters of the synthesized carbon material, in fact, reproduce the parameters of the carbon powder added to the source material. The proposed method of synthesis makes it possible to use both porous powders with high values of the specific surface area and conductivity, and carbon powders with quite small values of the specific surface area. The optimal quantity and optimized sizes of particles of initiating carbon powders depend on different parameters of synthesized porous carbon materials. An increase of conductivity of the initiating powder brings about high values of conductivity of synthesized porous carbon powder. Along with an increase of the ratio of the mass of the initiating powder and the source organic substance, the sizes of particles of the synthesized carbon powder decrease.

When porous carbon materials are synthesized, the use of porous carbon powders as an initiating dopant is preferable. This plays a special role, when, as a source material, use is made of organic substances which are fully or partially dissolved in water and have small sizes of molecules (in an example embodiment, synthesized carbon powders have particles' sizes that do not exceed 0.5 μm). When the sizes of the molecules of the organic substance are smaller than the carbon powder's pores, the molecules of the dissolved organic substance quite effectively penetrate the powder's pores. In this case, initiated carbonization takes place in the pores and in the external surface of the carbon powder's particles. When the total volume of pores of the porous carbon powder added to the raw material is approximately 60-80% of the raw material's volume, the initiated carbonization proceeds mostly in the powder's pores. This prevents the process of the joining of small particles of the synthesized carbon powder, and the carbon particles have increased concentration of structural defects. Accordingly, as it will be shown below, this makes it possible to perform an effective activation of powders. This aspect of the proposed method makes it possible to synthesize porous carbon powders with small sizes of particles and high specific capacitance parameters for the manufacture of electrochemical capacitors with high values of specific energy.

For the manufacture of electrodes of electrochemical capacitors based on porous carbon materials, use of carbon materials in the form of powders with 1-5 μm average sizes of particles is preferred. Usually, carbon powders are obtained by breaking large particles of the porous carbon materials after their synthesis. Unlike the currently known methods of synthesis of porous carbon materials, there is no use of a process of breaking in the proposed method, and carbon powders are obtained immediately after their synthesis. The sizes of the powders' particles are easily controlled when these powders are synthesized. Apart from higher manufacturability, there is a considerable difference between the densities of the surface states of the porous carbon powders obtained during the synthesis and by breaking after the synthesis.

The porous powder obtained during the synthesis has higher density of the surface states and, accordingly, a high value of specific capacitance than the powder subjected to breaking (at similar values of sizes of their particles and specific surface area). The sizes of particles of the carbon powders, synthesized by the proposed method, may be easily modified in 0.2 μm—several millimeters range by changing the modes and conditions of the powders' synthesis. However, the obtaining of carbon powder particles of the sizes of not more than 25 μm is preferable. This is determined by the fact that the formation of pores during the activation of particles having their sizes of more than 25 μm is difficult, and, as a rule, the powders containing a considerable number of large particles have low values of the specific surface area.

Since the carbon materials obtained by carbonization of solid organic raw material have, as a rule, underdeveloped porous structure and low area of the developed surface, in order to increase the volume of their pores and surface area, the carbon materials are preferably subjected to chemical and/or physical activation. In the process of activation of the carbon materials, there is an increase of the number of pores, their total volume and specific surface area of the materials; furthermore, there is a change of the ratio between the volumes of micropores, mesopores and macropores. The rate, efficiency of activation, sizes and structure of the pores of the carbon materials in the process of their activation depend considerably on the rate of the structural order of the source carbon material. The process of activation proceeds in a most effective and fast manner along the interfaces of the granules of the carbon particles and in the disordered areas of their crystals. Furthermore, the carbon particles with high concentration of structural defects are activated more evenly by their volumes, and the distribution of the pore volume by sizes has a narrow half-width.

During a moderate activation (by conventional methods) of standard carbon powders, whose particles have a low content of structural defects, the near-surface layers of the carbon particles are activated more effectively, which brings about low values of the specific surface area. However, the pores of such powders have quite close sizes. When the specific surface area is increased by means of an increase of duration and/or temperature of activation, the pores of the near-surface layers of the carbon particles widen very much and the thicknesses of the walls between the near-surface layers decrease. This, despite the large specific surface area, does not bring about an increase of DEL specific capacitance of porous powders. Therefore, the high concentration of structural defects of the particles of the carbon powders synthesized by the proposed method makes it possible to perform their effective activation, and to control, in a wide range, sizes of the powders' pores and, accordingly, their specific surface area.

The carbon materials designed for the manufacture of electrochemical capacitors should contain, unlike other porous carbon materials, a minimum amount of foreign impurities which bring about increased values of the capacitor self-discharge. For the use of porous carbon materials in electrochemical capacitors a particularly important role is played by the content of Fe, Mn, Cr, Ni, Ti impurities and other transitional elements in carbon materials. The content of these impurities in the carbon material, apart from an increase of self-discharge, often decreases the overpotential of evolution of hydrogen and oxygen, which results in a considerable decrease of the specific energy and capacity parameters of electrochemical capacitors. Therefore, it is preferable to use source organic substances with a low content of undesirable impurities, primarily Fe and Mn, which are most common impurities in carbon materials and have the most negative effect on the parameters of electrochemical capacitors. Because the output of porous carbon material from dry organic substances is usually 20-25%, subject to the synthesis technology and total specific volume of pores, it follows that after the synthesis the content of impurities in the carbon materials grows approximately 4 times.

During the synthesis of porous carbon materials use is made of different auxiliary materials, accordingly, the synthesis technology of porous carbon materials should rule out an increase of the concentration of foreign impurities by their transfer from the auxiliary materials into the carbon material during synthesis. Usually, the content of uncontrolled impurities grows considerably in the process of activation of the carbon materials.

In practice, for physical activation of carbon materials, use is preferably made of water vapors or CO₂ gas. The activation of carbon materials is usually performed at the temperature of about 800-1,000° C. For chemical activation of carbon powders use is usually made of such auxiliary materials as KOH, ZnCl₂, KMnO₄, etc. Despite the fact that, following the activation process, long-time treatment of the activated carbon materials is performed, some components or foreign impurities contained therein are left in small-size pores of the porous carbon materials. For example, in one embodiment, when use is made of KMnO₄ for the purposes of activation, a large amount of manganese ions is left in the carbon material.

It follows that for the synthesis of porous carbon materials designed for the manufacture of electrochemical capacitors it is preferable to use auxiliary materials that are clean. The use of clean materials brings about an increase of the cost of carbon materials and capacitors in general. Often, for the activation of carbon materials, use is made of auxiliary materials which are decomposed after the process of activation. The products of their decomposition are easily removed from the pores of the carbon materials. This method of activation makes it possible to synthesize cleaner porous carbon powders. In this case any possibility of regeneration of auxiliary materials for repeated use is ruled out, which results in higher costs of the synthesized carbon powders. Therefore, the list and quantity of auxiliary materials in the proposed method of synthesis are considerably minimized as compared with the other known methods, and such auxiliary materials which may be repeatedly used in the process of synthesis are preferably applied.

Unlike the known methods of synthesis of porous carbon materials, the proposed method preferably uses different organic substances which have a vegetal origin. The carbohydrate organic substances which are obtained by photosynthesis have a very low content of metal impurities and ash, and secondly, the world's production of carbohydrate substances of vegetal origin has a very large volume and a relatively low price. This makes it possible to synthesize porous carbon materials with a low cost and use them widely in different areas of engineering, including commercial manufacture of electrochemical capacitors, in industrial, ecological and medical applications.

Porous carbon powders have the best parameters when used as an organic carbohydrate substance of monosaccharides (C₆H₁₂O₆), disaccharides (C₁₂H₂₂O₁₁) and polysaccharides ((C₆H₁₀O₅)ₙ where n is a whole number). In the proposed method of synthesis, the main auxiliary substance is distilled water. A full or partial solubility of the source organic substance in water is a factor to consider in synthesis. If most substances containing monosaccharides and disaccharides in different molecular structures have very high solubility in water, the solubility of polysaccharides decreases considerably along with an increase of sizes of their molecules.

When in polysaccharides the number of glucose residues does not exceed 8000 (for example, amylose and amylopectin), polysaccharides are quite effectively dissolved or, at least, swelled in water. But at n>8000 (for example, cellulose), the solubility of polysaccharides has quite low values. In this case, spontaneous carbonization of molecules is highly probable at the stage of the preliminary initiated carbonization. However, according to the proposed method, when polysaccharides are used with a great number (up to 15,000) of glucose residues in the molecule, under the influence of dehydrating components during a preliminary carbonization there occurs a breaking of a part of hydrogen bridge bonds of the molecules. This results in a decrease of the number of glucose residues of the molecules and initiated carbonization of polysaccharides. Despite the fact that the synthesized porous carbon materials made of polysaccharides, with the number of glucose residues in the molecules up to 15,000, have high specific capacity parameters and conductivity, the use of polysaccharides in which the number of glucose residues does not exceed 10,000 is preferable.

One of the most effective methods of increasing the conductivity of the pore walls and specific capacitance parameters of porous carbon materials is by doping them with Boron atoms. The Boron atoms located in the sites of lattice of the pore walls create p-type conductivity which brings about an increase of equilibrium concentration of holes, and of conductivity and the pore walls respectively. This simultaneously provides for high specific energy and power parameters of electrochemical capacitors. Since at high values of the Boron concentration the probability of the formation of Boron carbide grows dramatically, which brings about an abrupt increase of the resistance of the pore walls, the maximum content of Boron in the powders preferably should not exceed 2 atomic %. The content of about 0.2-1 atomic % of Boron in the porous carbon powders is preferable.

The efficiency of the Boron introduction in the lattice sites of the crystal lattice of the pore walls, apart from the duration of the doping process, depends on the types, concentrations of structural defects of particular carbon materials and temperature of doping. Therefore, according to this invention, by means of increasing gradually the temperature and duration of the carbonization and activation process it is possible to determine optimal modes of the synthesis of the porous carbon powders made of different carbohydrate substances—in one embodiment doped by Boron.

Usually, the diffusion of Boron atoms in the walls of the porous carbon materials is perceptible at the temperature of >750° C. For effective doping of the porous carbon materials by Boron, it is preferable to use a mixture of Boron-containing compound with a carbohydrate substance before its pre-initiated carbonization. In one embodiment, the carbonization and activation process is performed at the temperature of not less than 800° C. with the duration of not less than 60 minutes. At the carbonization and activation temperature T=800° C., with the process duration of about 60 minutes, the main part of the Boron atoms takes the crystal lattice's site position in all the carbon powders synthesized from different carbohydrate substances.

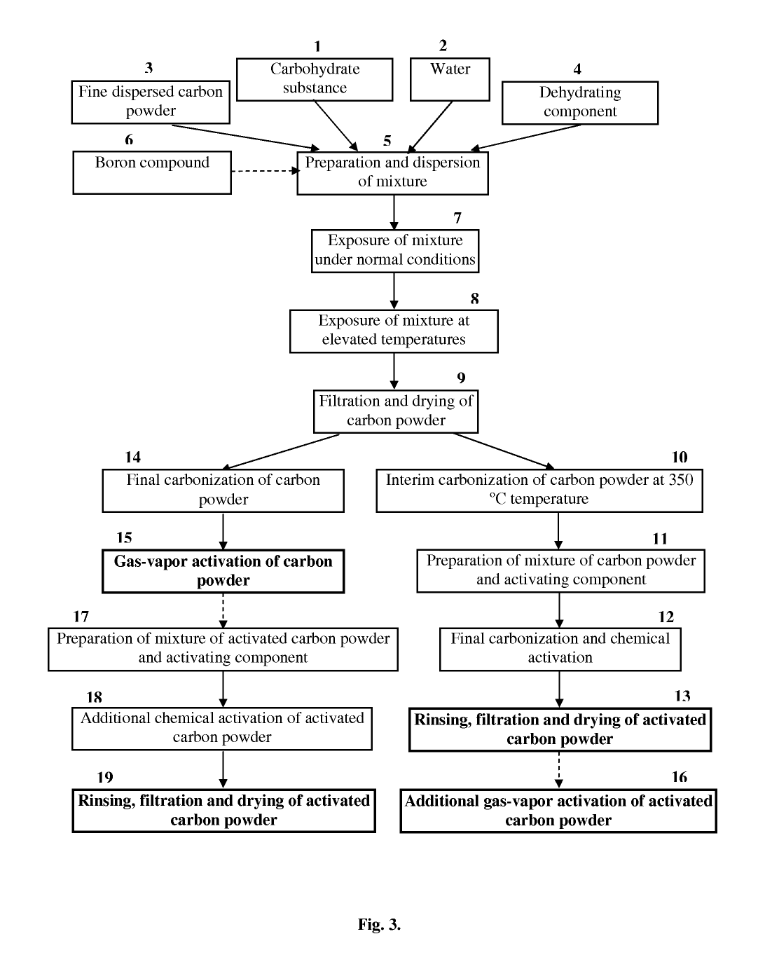

According to the preferred embodiments of this invention, the synthesis of porous carbon materials is performed as per the process flowsheet shown in FIG. 3. The carbohydrate substance (1) of one type or mixture of several types of carbohydrate substances is fully or partially dissolved in water (2). After that, fine-dispersed carbon powder (3) and dehydrating component (4) are added to the obtained solution. As a dehydrating component, use is made of sulfuric acid, phosphoric acid, nitrogen acid or their different mixtures. The use of sulfuric acid is preferable. In the oxidizers, a considerable part of metal impurities of the carbohydrate substance is dissolved and removed in the subsequent processes of synthesis. This brings about a decrease of the content of impurities in the carbon powder. Since the ratio of the amount of water and carbon of the carbohydrate substance in the mixture is quite high and there is also a high probability of transfer of the impurities from the water into the synthesized carbon material, the use of distilled water is preferable for the synthesis of carbon materials with a low content of uncontrolled impurity atoms.

During the synthesis of porous carbon powders doped by Boron atoms, Boron compound (6) is added to the mixture (5). In the proposed technology use is made of such Boron compounds which are dissolved in water and/or in dehydrating components and from which Boron is reduced by carbon at the temperature of not more than 1,000° C. For the synthesis of porous carbon powders doped with Boron, having a low content of other impurity atoms, it is preferable to use Boron-containing compounds which, apart from the Boron atoms, comprise atoms of hydrogen, oxygen, carbon and nitrogen.

In the preferred embodiment, the obtained mixture (5) is dispersed, and thereafter the mixture is held at room temperature (7) for a preliminary initiated carbonization of the carbohydrate substance. The sizes of carbon particles are changed in a wide range by changing the mixture's temperature during initiated carbonization in 20-50° C. temperature range. The duration of the process depends on its temperature and changes in the 0.5-10 hours time interval.

Thereafter, the process of preliminary initiated carbonization is preferably continued at elevated temperatures (8). The optimal temperature of this process is in the 120-180° C. range, and the duration is preferably about 0.5-5 hours subject to the type of the carbohydrate substance used. After the completion of the process of the initiated preliminary carbonization of the carbohydrate substance, the carbon powder is preferably extracted from the mixture by means of filtration and the drying of the powder (9).

During the powder's chemical activation, the powder is first subjected to intermediate carbonization (10) at a temperature of between about 250-350° C. for 1-3 hours. This process is preferably performed in an inert gas (nitrogen, argon, helium) medium or in the vacuum. Thereafter, a mixture of carbon powder and activated component (11) is made. For this purpose, the carbon powder is preferably mixed with aqueous solution or suspension of activated reagent and then the water is evaporated. The obtained dry mixture is subjected to final carbonization and chemical activation (12). This process is preferably performed in inert gas medium or in the vacuum at the temperature in the range of 600-1,000° C. The duration of the process is preferably from 20 minutes to 6 hours, subject to the temperature of the process and required parameters of the porous carbon powders. With a view of removing the residual activating reagent from the synthesized porous carbon powder, the powder is rinsed by distilled water, filtered and dried (13).

During the gas-vapor activation after the filtration and drying of the carbon powder (9), final carbonization (14) and activation of the carbon powder is preferably performed by hot water vapor or CO₂ gas (15). The final carbonization is preferably performed at a temperature of between about 600-800° C. for between about 0.5-1.5 hours. The activation temperature is preferably in the range of 700-1,000° C. and the activation duration is preferably in the range of about 1-6 hours.

The synthesized porous carbon powders, whose porous structure is created by chemical activation, may be subjected to additional activation (16) by hot water vapor or carbon dioxide to improve the parameters of the pores and increase the specific surface area of the powders. The porous carbon powders, whose porous structures are created by gas-vapor activation, may be subjected to repeated chemical activation. For this purpose, a mixture of the carbon powder, which is pre-activated by gas-vapor method, and the activated component (17) are prepared. Then, an additional chemical activation of the powder (18) is performed, thereafter the powder is rinsed, filtered and dried (19).

Described below are several exemplary embodiments of the invention which do not limit the framework of the proposed method of synthesis of the porous carbon materials, but only show a great potential and high effectiveness of the invention. These embodiments have high values of specific capacitance and low values of specific resistance

The measurement of the specific resistance of the carbon powders was taken by a two-probe method with the use of a special device (20) having a design shown in FIG. 3. In order to measure the dependence of the specific resistance of the carbon powder, the powder (21) was filled in the effective volume of the cylinder case (22) of the device which was made of a durable electrical insulating material with the internal cross-section S. Two ring measuring probes (23) were fixed inside the case; the distance between the probes was L. The measuring probes were made of graphite with high conductivity. A graphite probe—unlike the metal ones—with the carbon powder creates an insignificant contact potential, which makes it possible to measure, with high accuracy, specific resistance of the powders with different values of acidity. The mechanical pressure (P) is applied on the dies (24) made of rigid electrical insulating material and with the use of metal leads (25) measurements are taken to determine resistance between the measuring probes. By changing P value, measurements are taken to determine the dependence of the resistance of the powders on the mechanical pressure. The specific resistance of the powders (p) is calculated by the following formula:

$$ρ = \frac{R \cdot S}{L} . \qquad ( 7 )$$

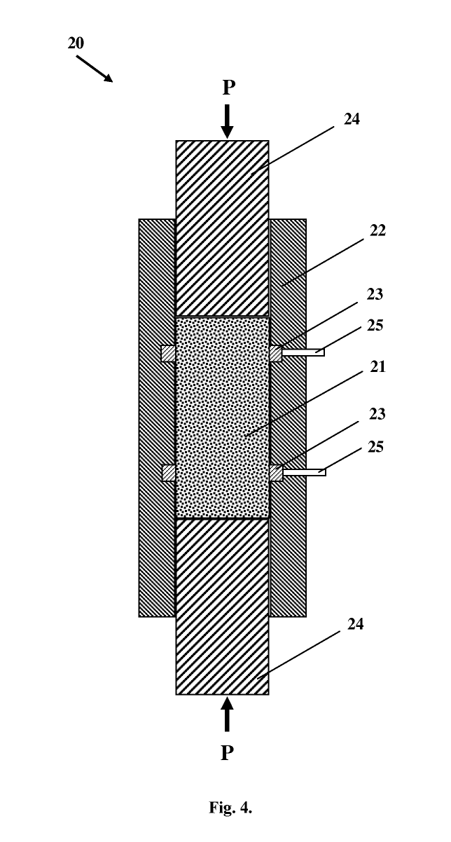

In order to measure the specific capacitance of the synthesized porous carbon powders, with a view of increasing the accuracy of the measured parameters during the manufacture of electrodes with DEL of an electrochemical capacitor, use was made of only the carbon powders without a binder. The testing of capacitance parameters of the carbon powders was performed in a heterogeneous electrochemical supercapacitor (HES) of PbO₂|H₂SO₄|C system with a design shown in FIG. 4.

The electrodes with DEL of the capacitor (26) were manufactured as follows: 4 g of the carbon powder under review was mixed with the electrolyte of sulfuric acid aqueous solution having 1.26 g/cm³ density. The obtained paste based on the carbon powder (27) was placed in a bag made of the separator (28) of FPP type having 100 μm thickness and Rexam conductive polymer (29) of 50 μm thickness. Thereafter, the separator was welded to Rexam polymer at the top of the bag and, by subsequent rolling and pressing of the powder in the bag, the electrode's active material of 50×70×1.7 mm³ overall dimensions was made.

In the HES (26), use was made of positive electrodes (30) with PbO₂/PbSO₄ active mass and 50×70×1.4 mm³ overall dimensions. The Coulombic capacity of the positive electrodes exceeds twice as much the maximum Coulombic capacity of the capacitors' negative electrodes. The current collectors (31) of the negative electrodes with 50×70×0.26 mm overall dimensions were made of lead alloy and had a conductive protective coating. The electrode pack (27, 28, 29, 30, 31) of each capacitor was placed in the case (32) and the capacitors were filled with the electrolyte (33) of aqueous solution of sulfuric acid having 1.26 g/cm³ density. After the manufacture of the capacitors they were placed in a special device which provided for an even pressure (about 5 kg/cm²) on the capacitors' electrodes.

Before the start of the testing of the capacity and energy parameters of the capacitors, the balancing of the Coulombic capacities of their positive and negative electrodes was performed. When the electrodes' Coloumbic capacities were balanced, the capacitors were charged and discharged by constant current with a considerable overcharge of the negative electrodes. The discharge of the capacitors, during their balancing and parameters' testing, was performed to the voltage of 0.8 V. After the balancing, the testing was performed of the capacity and energy parameters of the capacitors with different levels of the states of their charge during their charge and discharge by constant current in 30-350 mA range. The durations of pauses after the charge and discharge were 5 minutes.

When the maximum capacity and energy parameters of the capacitors discharged to 0.8 V were measured, the capacitors were charged by 30 mA constant current. The charge Coulombic capacity of the capacitors was 1.2-1.55 Ah, subject to the value of the maximum specific capacitance of the carbon powder measured.

In the process of the charge and discharge of the capacitors, measurements were taken to determine the potentials (φ₋) of their negative electrodes (in relation to the potential of PbO₂/PbSO₄ reference electrode) and |Z| impedance at the cycle frequency of 337 s⁻¹.

### EXAMPLES

### Example 1

The carbohydrate substance C₁₂H₂₂O₁₁ (saccharose) with a dry mass of 40 g was dissolved in 60 ml of distilled water. 30 g of concentrated sulfuric acid of high purity and 5 g of porous carbon powder as seed were added in the obtained solution. The values of the specific resistance ρ (at the pressure of 475 kg/cm²) and the maximum specific capacitance of the carbon powder used in the aqueous solution of sulfuric acid had the value of 4.1 Ohm·cm and 750 F/g respectively. After the dispersion, the mixture was held at the temperature of 25° C. for 5 hours. Further, the mixture was heated at the temperature of 120° C. for one hour. After the mixture's cooling, the powder of the carbonized carbon was filtered, rinsed by distilled water and dried. The powder mass after the drying was 21.7 g. Thereafter, the obtained powder was subjected to preliminary carbonization at the temperature of 350° C. for 2 hours in nitrogen atmosphere. After this procedure, the powder's mass decreased to 20.8 g.

The final carbonization and activation of the powder was performed in the presence of KOH in the vacuum at the temperature of 800° C. for 30 minutes and at the pressure of 5·10⁻⁴ Pa. For this purpose, KOH of 10.3 g mass was dissolved in distilled water. Then KOH aqueous solution was thoroughly mixed with the carbon powder and the obtained mixture was dried.

After the final carbonization and activation, the residual amount of KOH was removed from the powder. The mass of the synthesized porous carbon powder made of saccharose (PCPS-#1) was 15.2 g (Table 1), i.e. the output of the porous carbon powder made of saccharose is 10.2 g, with no account of the seed powder's mass, i.e. in the above-mentioned conditions of the synthesis the output of the saccharose porous carbon powder is 25.5% with no account of the seed powder.

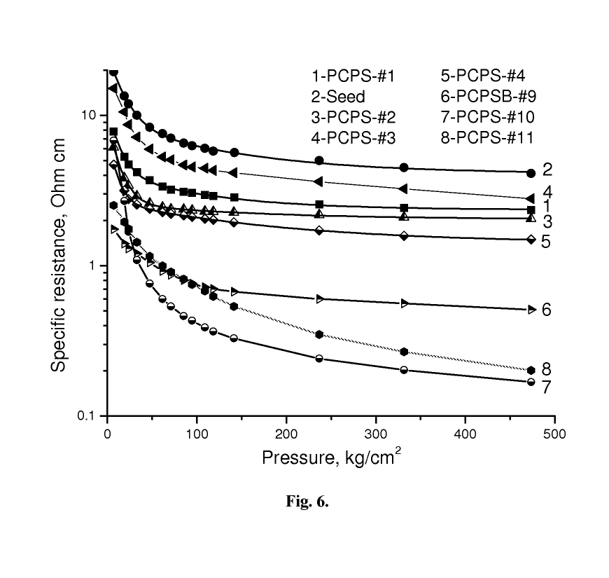

The patterns of the dependences ρ(p) of PCPS-#1 powders (FIG. 6, curve 1) and seed (FIG. 6, curve 2), in fact, coincide and are exponential in the range of 7-475 kg/cm² pressures. The values ρ of PCPS-#1 powders and seed at the pressure of about 7 kg/cm² are 7.8 Ohm·cm and 19.5 Ohm·cm respectively. At the pressure of 100 kg/cm² the specific electrical resistance of PCPS-#1 powders and the seed decrease considerably, and, thereafter, along with an increase of the pressure up to 475 kg/cm² there occurs a slow decrease of the powders resistances. At p=475 kg/cm² the value of the specific resistance of PCPS-#1 powder is 2.35 Ohm·cm, and of the seed powder, 4.1 Ohm·cm.

The obtained results of the research of ρ(p) dependence of carbon powders on the pressure make it possible to draw a conclusion that the synthesized PCPS-#1 powder has a lower contact resistance between the powder's particles than the seed powder. Since at high pressures the specific resistance of PCPS-#1 powder is lower than the one of the seed powder, then, according to the proposed method, the synthesized PCPS-#1 powder should have a higher value of the specific DEL capacitance.

The testing of the specific capacity and energy parameters of PCPS-#1 powder, as a component of the HES (HES #1), during its charge and discharge by constant currents in 30-280 mA range with 2.8-40 hours duration of the charge process showed that specific capacitance (Cₘ) value was in 636-876 F/g range, and specific energy (Eₘ) value was in the 721-1,008 J/g range. When the maximum capacity and energy parameters were measured, HES #1 was charged by 30 mA current with 1.2 Ah charge Coulombic capacity (charge time—40 hours) and discharged by 120 mA current up to the voltage of 0.8 V.

The measurements of the specific capacity and energy parameters of PCPS-#1 powder show that, first, the maximum specific capacitance (Cₘ^{max}) of the powder has a quite high value (876 F/g, Table 2), and, secondly, these measurements confirm that the value Cₘ^{max} of PCPS-#1 powder is higher than the specific capacitance of the seed powder (750 F/g).

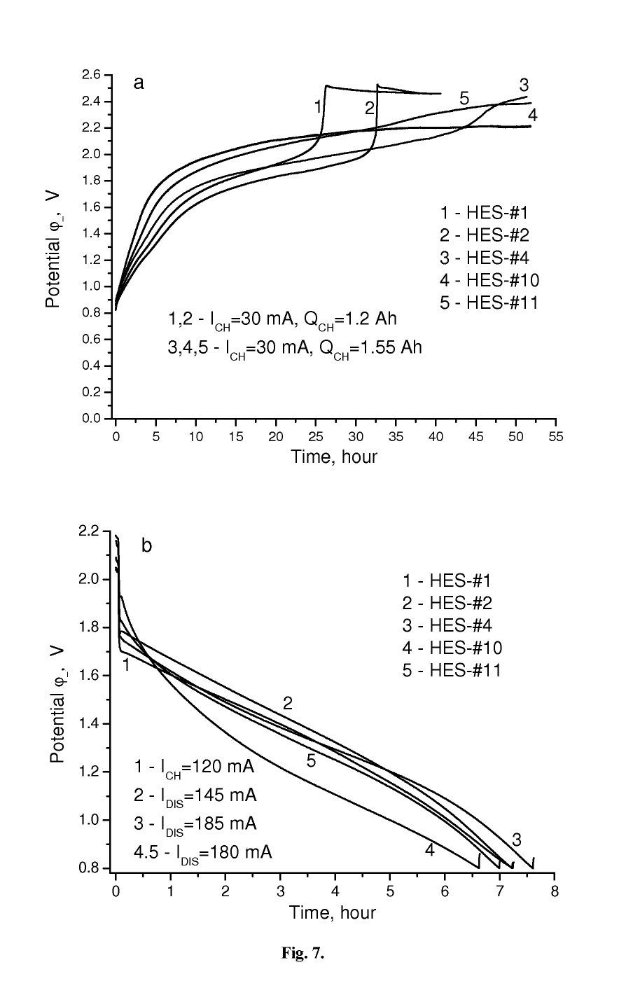

The time dependence of the potential of the negative electrode (φ₋(t) of HES #1 during its charge by 30 mA constant current (FIG. 7a, curve 1) shows that φ₋(t) potential during the capacitor's charge grows in a quite linear manner up to the value of about 1.6 V, i.e. in 0.8-1.6 V potential range the capacitance of PCPS-#1 powder does not, in fact, depend on the potential's value. When φ₋(t) value is higher than 1.6 V, the rate of the potential's growth, along with an increase of the level of the capacitor's state of charge, decreases in a monotonic manner, i.e. along with the growth of the potential the negative electrode's capacitance grows. FIG. 7 shows that this process continues up to φ₋(t) value of about 2.2 V, and thereafter there occurs an uneven growth of the potential.

The uneven change of the potential is observed only at the final stage of the capacitor's charge at a high level of the state of its charge and is determined by a change of the contact resistance between the carbon powder's particles. When the capacitor is fully charged, there occurs a strong interaction between electrically charged particles of the carbon powder, which brings about an increase of the distance between the particles and, accordingly, the contact resistance between them. The value of the potential's surge depends on the specific resistance, dimensions, physical parameters of particular carbon powder and parameters of the capacitor's mode of charge. Since in electrochemical capacitors use is generally made of carbon plates based on porous carbon powders and binding materials which provide for a porous mechanical bond between the carbon particles, the carbon plates' potential does not have an uneven change even at the maximum level of the state of the capacitors' charge.

The dependence of φ₋(t) during the discharge of HES #1 shows that the potential of the negative electrode in a quite wide range has, in fact, a linear pattern (FIG. 7b, curve 1). The linearity of the dependence is affected insignificantly only at the final stage of discharge, i.e. DEL capacitance of the powder during the capacitor's discharge does not, in fact, depend on the negative electrode's potential. However, the value of DEL capacitance of the HES depends significantly on the value of the potential of its negative electrode during the capacitor's charge.

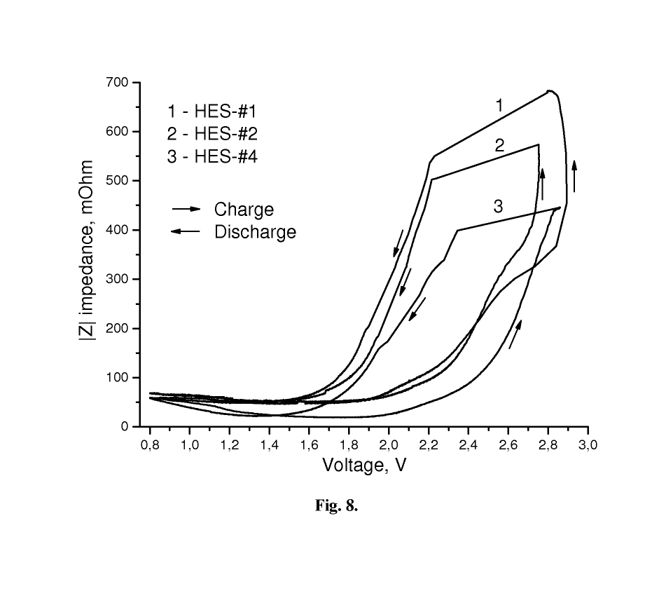

According to this invention, the change of DEL capacitance, at a high level of the capacitor's state of charge is mostly determined by a significant change of the concentration of the majority charge carriers in the pore walls and density of the surface states of the carbon powder. The change of conductivity of the carbon powder during the capacitor's charge and discharge is also confirmed by a considerable change of the dependence of |Z| impedance of HES #1 on its voltage (FIG. 8, curve 1). FIG. 8 shows that in 0.8-1.6 V voltage range the value of |Z| impedance of HES #1 changes insignificantly both during the charge and discharge. In 1.6-2.45 V voltage range the capacitor's impedance during the charge grows in a monotonic manner and further during uneven change of φ₋potential there occurs an uneven growth of |Z| impedance which continues until the end of the charge process. When the charge current is turned off, |Z| impedance decreases dramatically during a 5-minute pause, and then decreases in a monotonic manner until the end of the capacitor's discharge. The value of |Z| impedance of HES#1 at the end of charge and at the end of discharge is 682 mOhm and 59 mOhm respectively.

### Example 2

The porous carbon powder (PCPS-#2) was synthesized from saccharose in similar modes of synthesis of PCPS-#1 powder (Example 1) with similar ratios of all the mixture's components, except for the seed powder whose mass was 2.5 g (Table 1). The effective output of PCPS-#2 powder is not less than 24.7% with no account of the seed mass, and insignificantly lower than the respective parameter of PCPS-#1 powder.

The dependence of ρ(p) of PCPS-#2 powder (FIG. 6, curve 3) shows that the value of ρ at the pressure of 7 kg/cm² and 475 kg/cm² is 6.2 Ohm·cm and 2.05 Ohm·cm respectively.

The testing of the specific capacity and energy parameters of PCPS-#2 powder as a component of the HES (HES #2) was performed in the modes of the testing of HES #1, except for the discharge current value (145 mA) during the measurements of the maximum capacity and energy parameters. The results of the testing showed that the low value of the specific resistance of PCPS-#2 powder as compared with the respective parameter of PCPS-#1 powder provides for a higher value of the specific capacitance in different modes of charge and discharge of HES #2. The value Cₘ of PCPS-#2 powder was in 755-1,055 F/g range, and the value of Eₘ was in 890-1,202 J/g range—i.e., Cₘ^{max} of DEL of PCPS-#2 powder has a value of 1,015 F/g (Table 2).

The time dependence of the potential of the negative electrode of HES #1 (FIG. 7, curve 2) shows that both during the charge and discharge the potential's dependence has the pattern which is close to the dependence of the potential of HES #1 (FIG. 7, curve 1). During the charge of HES #2 and HES #1 by 30 mA constant current, φ₋(t) growth rate of HES #2 in the entire potential's range is lower than φ₋(t) growth rate of HES #1, which brings about a higher value of the maximum specific capacitance of PCPS-#2 powder (Table 2). The time of discharge of HES #1 and HES #2 has, in fact, a similar value (FIG. 7b, curves 1 and 2), and discharge currents of the said capacitors are 120 mA and 145 mA respectively. Consequently, the capacitance of HES #2 is approximately 1.2 times higher than the capacitance of HES #1, i.e. Cₘ^{max} value of PCPS-#2 powder is approximately 1.2 times higher than Cₘ^{max} value of PCPS-#1 powder.

The dependence of |Z| impedance of HES #2 is similar to the pattern of the dependence of the impedance of HES #2 (FIG. 8, curve 2). The value of |Z| impedance of HES #2 at the end of charge and discharge is 574 mOhm and 67 mOhm respectively.

### Example 3

The porous carbon powder (PCPS-#3) was synthesized from saccharose in identical modes of synthesis of PCPS-#1 powder (Example 1), with a similar ratio of all the components of the mixture, except for the seed powder whose mass was 1 g (Table 1). After the final carbonization and activation, dry PCPS-#3 powder had the mass of 10.5 g, i.e. the effective output of PCPS-#3 powder synthesized by the above method is not less than 26.2%, with no account of the seed mass.

The value of the specific resistance of PCPS-#3 powder at the pressure of 7 kg/cm² and 475 kg/cm² is 15.1 Ohm·cm and 2.8 Ohm·cm. The dependence of ρ(p) (FIG. 6, curve 4) shows that in 100-475 kg/cm² pressure range the rate of decrease of the specific resistance of PCPS-#3 powder is higher as compared with the rate of decrease of PCPS-#1 and PCPS-#2 powders. This is related to the fact that a decrease of the seed powder's amount in the mixture results in smaller sizes of the particles of PCPS-#3 powder and, accordingly, a stronger ρ(p) dependence of the powder in the area of the pressure's high values. FIG. 6, curve 4 shows that at the value of p>>475 kg/cm², ρ value of the powder closely approached the respective parameter of PCPS-#1 and PCPS-#2 powders, i.e. despite a higher value of the contact resistance of the particles of PCPS-#3 powder, the resistance of the walls of the pores of PCPS-#3 powder has the value which is very close to the resistance of the walls of the pores of PCPS-#1 and PCPS-#2 powders.

The testing of the specific capacity and energy parameters of PCPS-#3 powder as a component of the HES (HES-#3) was performed in the modes of testing of HES #1. The testing results showed that Cₘ value of PCPS-#3 powder was in 775-981 F/g range, and Eₘ value was in the 560-987 J/g range, i.e. Cₘ^{max} value of DEL of PCPS-#3 powder is 981 F/g (Table 2).

The value of |Z| impedance of HES #3 at the end of charge has the value of 714 mOhm, and at the end of discharge, 72 mOhm.

### Example 4

A porous carbon powder (PCPS-#4) was synthesized from saccharose with identical ratios of the mixture's components and in similar modes of synthesis of PCPS-#3 powder (Example 3), except for the duration of final carbonization and activation which was 60 minutes. The mass of the synthesized PCPS-#4 powder was 7.9 g (Table 1) and the effective output—not less than 17.2% with no account of the seed mass.

The dependence of ρ(p) (FIG. 6, curve 5) shows that in the entire range of pressure the value of the specific resistance of PCPS-#4 powder is lower than the specific resistances of PCPS-#1, PCPS-#2 and PCPS-#3 powders. The value of ρ of PCPS-#4 powder at the pressure of 7 kg/cm² and 475 kg/cm² pressure is 4.7 Ohm·cm and 1.5 Ohm·cm respectively (Table 2). It is obvious that an increase of the duration of the final carbonization and activation results in a decrease of the specific resistance of the powder. Besides, both the contact resistance of the particles and the resistance of the walls of the powder's pores decrease.

The testing of the specific capacity and energy parameters of PCPS-#4 powder was performed in HES #4 during its charge and discharge by constant currents in 30-280 mA current range with 2.8-51.7 hours duration of the charge process. Cₘ and Eₘ values of PCPS-#4 powder were in the ranges of 862-1,375 F/g and 1134-1,645 J/g respectively. Cₘ^{max} value of DEL of PCPS-#4 powder was 1,375 F/g (Table 2). The obtained results show that Cₘ^{max} value of PCPS-#4 powder and capacitance of HES #4 respectively has a higher value than Cₘ^{max} of PCPS-#1, PCPS-#2 and PCPS-#3 powders. Therefore, in order to measure the maximum capacity and energy parameters of PCPS-#4 powder, HES #4 was charged by 30 mA current with 1.55 Ah charge Coulombic capacity (51.7 hours charge time) and discharged by 185 mA current to the voltage of 0.8 V.

The dependence of φ₋(t) potential during the charge of HES #4 (FIG. 7a, curve 3) shows that the dependence of the potential of its negative electrode has the pattern which is close to the dependences of the potentials of the negative electrodes of HES #1 and HES #2 (FIG. 7a, curves 1 and 2). Despite the fact that the maximum capacitance of HES #4 with PCPS-#4 powder is 1.57 times higher than the maximum capacitance of HES #1 with PCPS-#1 powder, during the charge of the capacitors by constant current, in 0.8-1.6 V potential range, the rate of growth of φ₋(t) of HES #4 is 1.2 times higher than the rate of growth of φ₋(t) of HES #1, i.e. in 0.8-1.6 V potential range the specific capacitance of PCPS-#4 powder is 1.2 times lower than the specific capacitance of PCPS-#1 powder. However, FIG. 7a shows that at the values of φ₋>1.6 V the potential of the negative electrode of HES #4 grows slower than the potential of the negative electrode of HES #1, i.e. at the value of the potential φ₋>1.6 V the capacitance of PCPS-#4 powder grows faster than the capacitance of PCPS-#1 powder. Therefore, at a high level of the state of charge of HESs Cₘ^{max} value of PCPS-#4 powder is higher than Cₘ^{max} value of PCPS-#1 powder.

The dependence of φ₋(t) at the final stage of discharge of HES #4 by constant current deviates more considerably from the linearity than φ₋(t) dependence of HESs #1 and #2 (FIG. 7b). This is related to the high value of the specific capacitance of DEL of PCPS-#4 powder which brings about greater changes of the volume and surface parameters of the walls of the pores of PCPS-#4 powder at a strong deviation of its potential from the potential of the zero charge.

Unlike the impedances of HES #1 and HES #2, the impedance of HES #4 in 0.8-1.5 V voltage range decreases during the discharge and grows during the charge (FIG. 8, curve 3). Besides, at the values of the charge voltage >2.45 V, |Z| impedance of HES #4 grows slower than the impedance of HES #1 and HES #2 (FIG. 8), i.e. a slight uneven growth of φ₋ potential of HES #4 at the final stage of its charge results in a slight uneven growth of |Z| impedance. The value of |Z| impedance of HES #4 at the end of the charge is 442 mOhm and at the end of discharge −58 mOhm.

### Example 5

In order to synthesize a porous carbon powder, use is made of a carbohydrate substance (C₆H₁₀O₅)ₙ, where the n value is in the 300-8,000 range (potato starch). 50 g of dry potato starch of high grade and 1 g of the seed powder were thoroughly mixed in 100 g of the distilled water. 40 g of concentrated sulfuric acid were added to the obtained mixture. First, the mixture was held at the temperature of 20° C. for 5 hours, then the mixture was heated at the temperature of 150° C. for 1 hour. When the mixture was cooled, the powder of the carbonized carbon was filtered, rinsed by distilled water and dried. The mass of the powder after the drying was 18.2 g. Thereafter, the obtained powder was subjected to preliminary carbonization at the temperature of 350° C. in a nitrogen atmosphere for 2 hours. After this procedure, the mass of the powder decreased to 16.1 g (Table 1).

The final carbonization and activation of the powder was performed in the presence of KOH and in a vacuum at a temperature of 800° C. for 35 minutes at 5·10⁻⁴ Pa pressure. For the purposes of the powder activation, 10 g of KOH was used. After the final carbonization and activation, the residual amount of KOH was removed from the powder. The mass of the synthesized activated powder (PCPST-#5) was 9.6 g (Table 1) and the effective output—not less than 19.2% with no account of the seed powder mass.

The value ρ of PCPST-#5 powder at the pressure of 7 kg/cm² and 475 kg/cm² is 12.9 Ohm·cm and 4.4 Ohm·cm respectively (Table 2). The results of the testing of the capacity and energy parameters of PCPST-#5 as a component of HES #5 in the modes of testing of HES #1 showed that the value Cₘ of the powder was in the range of 752-1,000 F/g and the value of Eₘ was in the range of 728-1,020 J/g, i.e. the value of Cₘ^{max} of DEL of PCPST-#5 powder is 1,000 F/g (Table 2).

The value of |Z| impedance of HES #5 at the end of charge and at the end of discharge was 752 mOhm and 85 mOhm respectively.

### Example 6

A carbohydrate substance C₆H₁₂O₆ (D-glucose) was used for the synthesis of porous carbon powder in this embodiment of the invention. D-glucose porous carbon powder (PCPG-#6) was synthesized under the similar conditions of synthesis of PCPS-#3 powder specified in Example 3, and with similar ratios of all the mixture's components (Table 1). The mass of PCPG-#6 powder was 10.8 g and the effective output was not less than 24.5% with no account of the seed powder mass.

The value of ρ of PCPG-#6 powder at the pressure of 7 kg/cm² has the value of 12.1 Ohm·cm and at the pressure of 475 kg/cm²-0.47 Ohm·cm (Table 2). The testing of the specific capacity and energy parameters of PCPG-#6 powder was performed in HES-#6 capacitor in the testing modes of HES #1 except for the value of the discharge current (110 mA) when the maximum capacity and energy parameters are measured. The testing results showed that the value of Cₘ of PCPG-#6 powder was in the range of 580-860 F/g, the value of Eₘ was in the rage of 750-1,122 J/g, i.e. the value of Cₘ^{max} of DEL of PCPG-#6 powder is 860 F/g (Table 2).

The value of |Z| impedance of HES #6 at the end of charge is 625 mOhm, and at the end of discharge, 50 mOhm.

### Example 7

In this embodiment of the invention, a porous carbon powder was synthesized from D-glucose (PCPG-#7) with similar ratios of the mixture's components and under the similar modes of the synthesis of PCPG-#6 powder, indicated in Example 6, except for the duration of the final carbonization and activation which was increased from 30 minutes to 45 minutes. The mass of PCPG-#7 powder was 9.1 g (Table 1) and the effective output was 20.2%, with no account of the seed powder mass.

The value of ρ of PCPG-7 powder at the pressure of 7 kg/cm² is 11.5 Ohm·cm and at the pressure of 475 kg/cm² was 2.05 Ohm·cm (Table 2). The testing of the capacity and energy parameters of PCPG-#7 powder was performed in HES #7 in the testing modes of HES #1 except for the value of the discharge current (130 mA) when the maximum capacity and energy parameters were measured. The value Cₘ of PCPG-#7 powder was in the range of 650-952 F/g and the value Eₘ was in the range of 854-1,254 J/g, i.e. the value Cₘ^{max} of DEL of PCPG-#7 powder is 952 F/g (Table 2).

The value of |Z| impedance of HES #7 at the end of charge was 690 mOhm, and at the end of discharge, 65 mOhm.

### Example 8

In this embodiment, porous carbon powder was synthesized with the use of zinc chloride. In order to synthesize carbon powder, 40 g of saccharose was dissolved in 45 ml of distilled water. 20 g of zinc chloride and 1 g of the seed powder were added. Following the mixture's homogenization, water was evaporated from the mixture and the obtained mass was subjected to thermal treatment at the temperature of 350° C. for 2 hours in nitrogen atmosphere. Following the said treatment, the mass of the mixture of the carbon powder and zinc chloride was 32.7 g. Thereafter, the powder was subjected to high-temperature treatment in the vacuum at the temperature of 800° C. for 35 minutes.

The mass of the obtained carbon powder after the thermal treatment was 13.2 g. To remove residual zinc chloride from the carbon powder, the powder was treated by concentrated hydrochloric acid, rinsed by distilled water, filtered and dried. Further, with a view of improving microporosity, the obtained porous carbon powder of 11.7 g mass was subjected to repeated activation in the presence of KOH. The ratio of KOH and porous carbon powder was 0.14. A repeated activation was performed in the vacuum at the temperature of 720° C. for 15 minutes. The mass and effective output of the obtained porous carbon powder (PCPS-#8) were 10.8 g and 24.5%, respectively, with no account of the seed powder mass.

The value ρ of PCPS-#8 at the pressure of 7 kg/cm² was 5.1 Ohm·cm and at the pressure of 475 kg/cm² was 3.8 Ohm·cm (Table 2). The testing of the capacity and energy parameters of PCPS-#8 powder was performed in HES #8 in the modes of the testing of HES #1, except for the value of the discharge current (140 mA) when measurements of the maximum capacity and energy parameters were taken. The value Cₘ of PCPS-#8 powder was in 672-943 F/g range and the value Eₘ was in the 861-1,218 J/g range, i.e. Cₘ^{max} value of DEL of PCPS=#8 powder is 943 F/g (Table 2).

The value of |Z| impedance of HES #8 at the end of charge is of 525 mOhm and at the end of discharge, 98 mOhm.

### Example 9

The synthesis of porous carbon powder (doped by Boron) from saccharose (PCPSB-#9) was similar to the synthesis of PCPS-#3 powder with identical ratios of the mixture's components and similar conditions of synthesis except for the duration of the final carbonization and activation, which amounted to 60 minutes. For the purposes of doping by Boron, use was made of Boron-containing H₃BO₃ compound of 1.65 g mass which was dissolved in distilled water during the mixture's preparation.

The dependencies of the specific resistance of PCPSB-#9 powder on the compression pressure (FIG. 6, curve 6) show that the conductivity of the powder doped by Boron both at low and at high pressures is considerably higher than the conductivity of different powders which do not contain Boron. At the pressure of 7 kg/cm², the value ρ of PCPSB-#9 powder is 1.75 Ohm·cm which is 8.6 times lower than the value of the respective parameter of PCPS-#3 powder synthesized under the similar conditions in the absence of Boron. At the pressure of 475 kg/cm² the value ρ of PCPSB-#9 powder (0.51 Ohm·cm) is 5.5 times lower than the specific resistance of PCPS-#3 powder (2.8 Ohm·cm).

Since at the low pressures the powders' resistance is mostly determined by the contact resistance between the particles, and at the high pressures, by the resistance of the pore walls, it is clear from the obtained results that the presence of Boron brings about a considerable decrease of the contact resistance of the carbon particles and resistance of their pore walls. Therefore, doping of porous carbon powders by Boron atoms will make it possible to manufacture electrochemical capacitors both with high specific energy and capacity parameters and with high specific powers of discharge.

The testing of the specific capacity and energy parameters of PCPSB-#9 powder in HES #9 during its charge and discharge by constant currents in 30-350 mA range with 2.2-40 hours duration of the charge process showed that Cₘ value of the powder was in the range of 903-1,216 F/g, and the value Eₘ was in the 1,020-1,342 J/g range, i.e. Cₘ^{max} value of DEL of PCPSB-#9 powder is 1,216 F/g (Table 2).

The value of |Z| impedance of HES #9 at the end of charge was 224 mOhm, and at the end of discharge, 36 mOhm.

### Example 10

40 g of saccharose were dissolved in 70 ml of distilled water. 1 g of the seed powder was added in the obtained mixture. 45 g of the concentrated sulfuric acid were slowly added in the obtained mixture. Thereafter, the mixture, after 2-hour exposure at room temperature, was heated at a temperature of 120° C. for 5 hours. After cooling of the mixture, the carbonized carbon powder was filtered, rinsed by distilled water and dried.

The final carbonization of the obtained powder was performed in the reactor of a specially developed installation designed to synthesize porous carbon powders with gas-vapor activation. The powder's carbonization was performed in a nitrogen atmosphere and the activation in a CO₂ flow.

After the carbon powder's placement in the installation's reactor, nitrogen delivery in the reactor's volume was turned on. The nitrogen delivery value was 0.05 l/h and the pressure was 50 kPa. Thereafter, the reactor's temperature for 3 hours increased slowly until it reached 930° C. Further, CO₂ delivery to the reactor was turned on with a flow value of 5 l/h, thereafter the nitrogen delivery was turned off. The process of the final carbonization and activation at the temperature of 930° C. was performed for 3 hours. Then the nitrogen delivery in the reactor was resumed and when the nitrogen pressure in the reactor was fixed at 50 kPa, CO₂ delivery was discontinued. The nitrogen delivery continued until the reactor is cooled down to the room temperature.

The average sizes of particles and specific surface area of PCPS-#10 powder were 45 μm and 925 m²/g respectively. The mass and effective output of the synthesized porous carbon powder (PCPS-#10) were 7.9 g and 17.3% respectively, with no account of the seed powder mass.

The measurement of the dependence of the specific resistance ρ(p) of PCPS-#10 powder on the external pressure showed that the exponential pattern of the dependence for the powder activated by carbon dioxide is retained (FIG. 6, curve 7). The value ρ of PCPS-#10 powder at the pressure of 7 kg/cm² and 475 kg/cm² was 6.8 Ohm·cm and 0.168 Ohm·cm respectively (Table 2). Despite the fact that at low pressures the specific resistance of PCPS-#10 powder (6.8 Ohm·cm) is 3.9 times higher than the specific resistance of PCPSB-#9 powder (1.75 Ohm·cm), ρ value of PCPS-#10 powder at the pressure of 475 kg/cm² (0.168 Ohm·cm) is 3 times lower than the specific resistance of PCPSB-#9 (0.51 Ohm·cm). Consequently, the conductivity of the pore walls of POPS-#10 powder has a higher value than the one of PCPSB-#9 powder.

The testing of the capacity and energy parameters of POPS-#10 powder in HES #10 in the modes of testing of HES #4 showed that Cₘ value of the powder was in the 847-1,081 F/g range and Eₘ value was in the 1,030-1,310 J/g range, i.e. Cₘ^{max} value of DEL of HES-#10 powder is 1081 F/g (Table 2).

The dependencies of φ₋(t) potentials of HES #10 and HES #4 (FIG. 7) show that during the charge of the said capacitors by 30 mA constant current the rate of φ₋(t) growth of the negative electrode of HES #10 in 0.8-1.7 V potential range is 1.6 times higher than the rate of φ₋(t) growth of HES #4 which is determined by the values of the specific surface areas of PCPS-#10 powder (925 m²/g) and PCPS-#4 powder (1,470 m²/g). Taking into account the fact that according to this invention at the values of the potential φ₋>1.7V, when the capacitance of DEL of porous carbon powders depends considerably on the values of the potential due to high conductivity of the walls of the pores of PCPS-#10 powder (Table 2), its Cₘ^{max} value (1,081 F/g) is only 1.27 times lower than Cₘ^{max} value of PCPS-#4 powder (1,375 F/g) despite a considerable difference of the specific surface areas of the said powders.

FIG. 7a shows that at the values of φ₋>1.7V the potential of the negative electrode of HES #10 grows slower than the potential of the negative electrode of HES #4, i.e. at the said values of the potential, the capacitance of DEL of PCPS-#10 powder grows faster than the one of PCPS-#4 powder. Besides, the low value of the specific resistance (0.168 Ohm·cm) of PCPS-#10 powder results in low values of the contact resistance between its particles. Therefore, at the final stage of the charge process of HES #10 at its maximum charge, an uneven growth of φ₋(t) potential is not observed. The absence of uneven growth of φ₋(t) of HES #10 is also partially determined by relatively large sizes of particles of PCPS-#10 carbon powder. Large sizes of the particles of PCPS-#10 carbon powder also determine a considerable deviation of φ₋(t) dependence from linearity at the initial stage of discharge of HES #10 (FIG. 7b).

Despite the low value of the specific Ohmic resistance of PCPS-#10 powder the negative electrode based on this powder has a higher value of ionic resistance. This results in high values of the polarization resistance of HES #10 and, accordingly, a considerable deviation from the linearity of the dependence of φ₋(t) potential of the negative electrode. Since the proposed technology of the synthesis of porous carbon powders makes it possible to control in a wide range (apart from the other parameters) sizes of the powders' particles, it is obvious that a decrease of sizes of the particles of PCPS-#10 powder will make it possible to decrease the polarization resistance and increase φ₋(t) linear dependence of the powder.

The value of |Z| impedance of HES #10 at the end of charge had the value of 180 mOhm and at the end of discharge, 32 mOhm.

This example shows that high specific capacity parameters of porous carbon powders may be obtained (apart from an increase of its specific surface area) by an increase of conductivity of the walls of the powders' pores. This feature of the technology of porous carbon powders'synthesis opens up a great opportunity of synthesizing powders with high specific capacity parameters and with low specific resistances for manufacture of electrochemical capacitors designed for high power charge and discharge with high specific discharge energy.

### Example 11

Porous carbon powder (PCPS-#11) was synthesized from saccharose in similar modes of synthesis of PCPS-#10 powder (Example 10) with similar ratios of all the mixture's components except for the amount of water and duration of the powder's activation. In order to decrease the sizes of the powder's particles, the amount of water in mixture was increased to 140 ml. The duration of the process of powder activation was 150 minutes.

After the final carbonization and activation, the mass of dry PCPS-#11 powder was 8.2 g, i.e. the effective output of PCPS-#11 powder had the value of not less than 18.0%, with no account of the seed powder mass. The sizes of the particles of PCPS-#11 powder were in the range of 0.4-5 μm.

The dependence of ρ(p) of PCPS-#11 powder on the external pressure (FIG. 6, curve 8) shows that the contact resistance between the particles and specific resistance of their pore walls has low values. The value of ρ of PCPS-#11 powder at the pressures of 7 kg/cm² and 475 kg/cm² was 2.52 Ohm·cm and 0.2 Ohm·cm, respectively (Table 2).

The testing of the capacity and energy parameters of PCPS-#11 powder was performed in HES #11 in the mode of testing of HES #10. Cₘ and Eₘ values of PCPS-#11 powder were in the range of 885-1,213 F/g and 1,078-1,467 J/g, respectively. The Cₘ^{max} value of DEL of PCPS-#11 powder was 1,213 F/g (Table 2).

The value of |Z| impedance of HES #11 at the end of charge was 220 mOhm and at the end of discharge, 35 mOhm.

During the charge of HESs #11 and #10, the potential of the negative electrode of HES #11 in 0.8-2.1 V range grows slower than the potential of the negative electrode of HES #10 (FIG. 7a). An increase of the rate of growth of φ₋(t) of HES capacitor #11 at φ₋>2.1V is determined by the growth of the contact resistance between the particles of PCPS-#11 powder at a high level of the capacitor's state of charge. Besides, the dependence of φ₋(t) potential during the discharge of HES #11 has a more linear pattern (FIG. 7b, curve 5) than φ₋(t) dependence of HES #10 (FIG. 7b, curve 4). The obtained results clearly show how a decrease of the average sizes of particles of the porous carbon powder results in the growth of the density of the surface states and, accordingly, specific capacitance of DEL of the powder.

According to this invention, the conductivity, densities of the surface states and capacitance of DEL of carbon powders depend on the powders' potential. In order to show the dependence of the capacitance on the potential of the porous carbon powder, HES #11 was charged and discharged by 100 mA constant current with the following duration of charge: 2 hours; 4 hours; 6 hours; 8 hours; 10 hours; 12 hours. In all the modes, the capacitor was discharged to the value of the negative electrode's potential of 0.8 V.

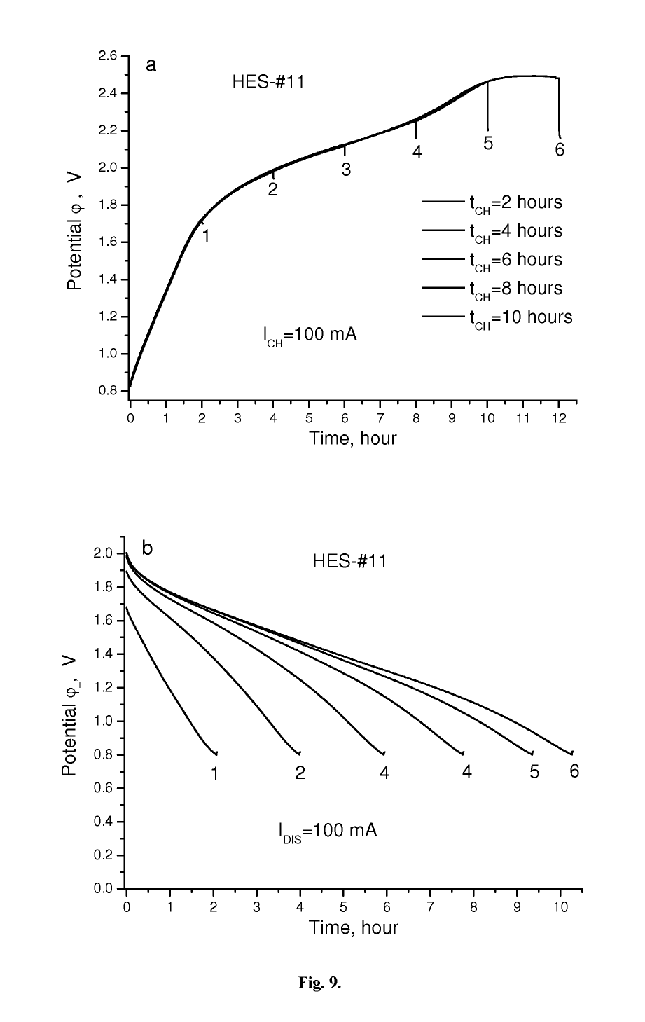

As it follows from FIG. 9a, the dependence of the potential of the negative electrode of HES #11 has a linear pattern only at a low level of the capacitor's state of charge. Along with an increase of the level of the capacitor's state of charge the non-linearity of the dependence increases. The dependence of φ₋(t) during the capacitor's discharge has a quite linear pattern, irrespective of the level of the capacitor's state of charge (FIG. 9b). Besides, along with an increase of the charge's duration from 2 hours to 12 hours the value of the potential of the charged capacitor's negative electrode grows from 1.67 V to 2.01 V. A slight growth of φ₋(t) of the charged capacitor at a six-fold increase of the level of its state of charge is related to the fact that along with an increase of the potential (in relation to the potential of PbO₂/PbSO₄ reference electrode) of the negative electrode the capacitance of DEL of the carbon powder grows.

The calculations of the average value of the negative electrode's capacitance as per the formula

$$C = \frac{2 {I}_{DIS} {\int }_{{I}_{BDIS}}^{{I}_{EDIS}} ϕ\_ ( t ) d t}{{ϕ}_{BDIS}^{2} - {ϕ}_{EDIS}^{2}} , \qquad ( 8 )$$

show that at the duration of charge: 2 hours; 4 hours; 8 hours; 10 hours; 12 hours, the capacitance's value is 825.6 F; 1332.5 F; 1915.8 F; 2491.3 F; 2952.5 F; 3208.8 F respectively. In the formula (8) I_{DIS} is the capacitor's discharge current, φ₋(t)—time dependence of the negative electrode's potential during the capacitor's discharge, t_{BDIS} and t_{EDIS}—time of begin and end of discharge, φ_{BDIS} and φ_{EDIS} is respectively the value of the negative electrode's potential at the beginning and at the end of the capacitor's discharge. It follows that the obtained results demonstrate a considerable dependence of the capacitance of DEL of the porous carbon powders on the potential or level of the state of their charge.

### Example 12

In order to demonstrate high values of the specific capacity and energy parameters of the carbon plates which are generally used for manufacture of electrochemical capacitors, a carbon plate was made on the basis of a porous carbon powder (PCPS-#12) synthesized from saccharose. PCPS-#12 powder was synthesized in similar fashion to the PCPS-#4 powder (see Example 4) with identical ratios of all the mixture's components, but a different duration of the process of final carbonization and activation which, in this case, amounted to 70 minutes. The maximum values of Cₘ^{max} of DEL and Eₘ^{max} of PCPS-#12 powder were determined to be 1,420 F/g and 1,698 J/g respectively (Table 2).

The carbon plate was manufactured by a method of rolling and had the following mass ratio of the components: porous carbon powder—89%; fine-dispersed black carbon with high conductivity—8%; PTFE (polytetrafluoroethylene) binding material—3%. The mass density and specific electrical resistance of the carbon plate had the values of 0.615 g/cm³ and 0.85 Ohm·cm, respectively.

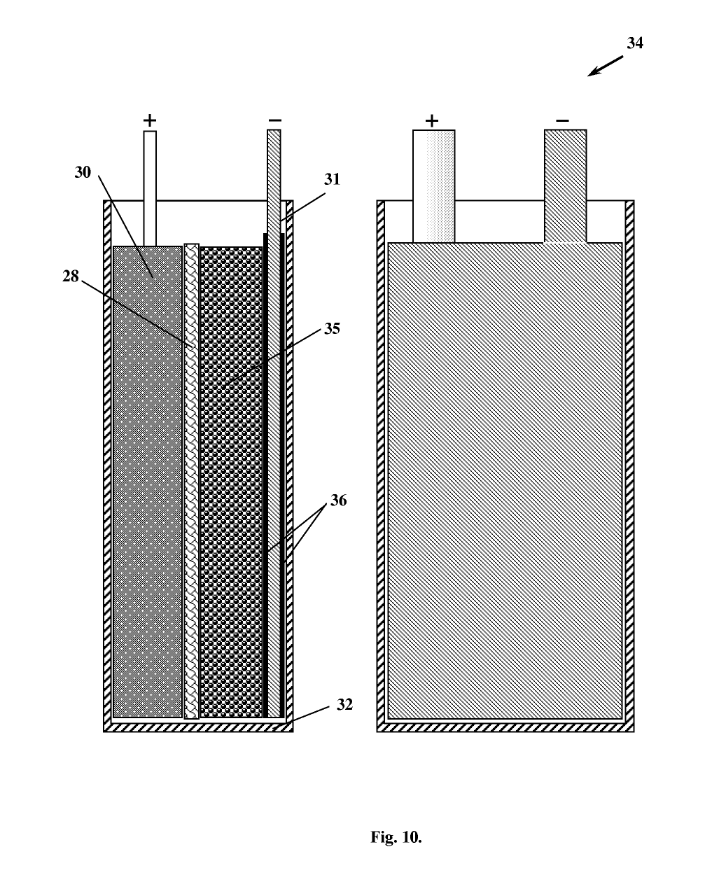

The testing of the specific capacity and electrical parameters of the carbon plate was performed on the capacitor (34) of a PbO₂|H₂SO₄|C system (HES #12) with the design shown in FIG. 10. HES #12 use was made of a positive electrode (30) with 135×70×2.5 mm overall dimensions, a carbon plate (35) with dimensions of 135×70×2.2 mm and a 12.8 g mass, a current collector (31) of the negative electrode with dimensions of 135×70×0.25 mm and made of lead alloy with a conductive protective coating (36), and an AGM-separator (28) of 0.6 mm thickness. HES #12 was filled with a rated amount of the electrolyte (33) of sulfuric acid aqueous solution having 1.26 g/cm³ density. The capacitor's electrolyte was in the pores of the positive, negative electrodes and separator and is not shown in FIG. 10.

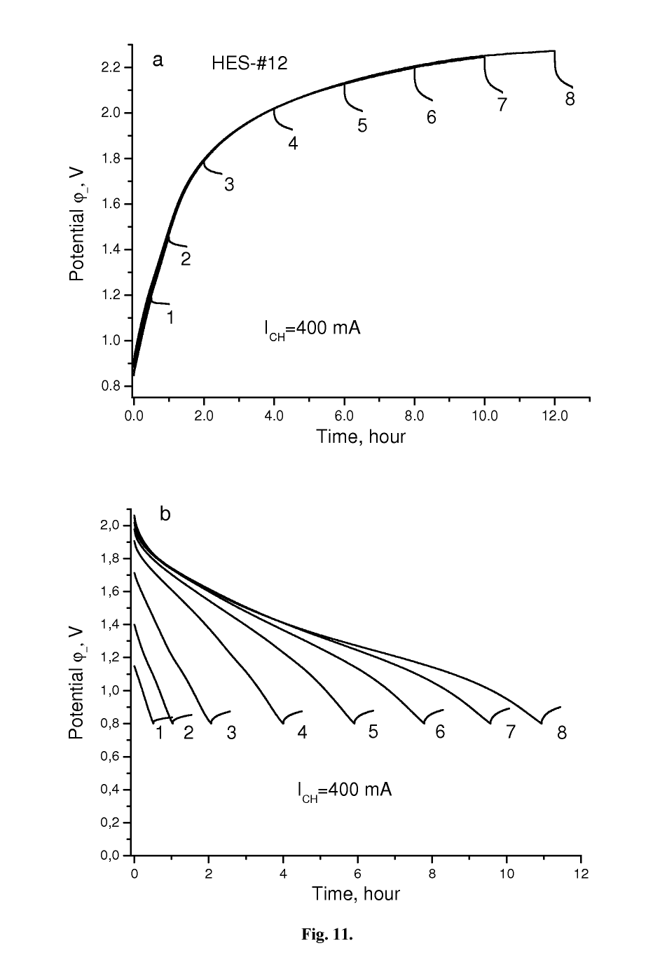

For measurements of the maximum values of the capacitance and discharge energy, HES #12 was charged and discharged by 950 mA constant current. The value of the charge Coulombic capacity was 5.2 Ah. The maximum value of the carbon plate's capacitance was 16,450 F. Further, HES #12 was charged and discharged by 400 mA constant current with the following duration of charge: 0.5 hour; 1 hour; 2 hours; 4 hours; 6 hours; 8 hours; 10 hours; 12 hours. The duration of pauses after the charge and after the discharge was 30 minutes. The capacitor's discharge during all the measurements was performed to the value of the negative electrode's potential of 0.8 V. The time dependences of the negative electrode's potential φ₋(t) of HES #12 in different modes of charge-discharge are shown in FIG. 11.

The calculations of the formula (8) of the values of the capacitance of the carbon plate of HES #12 with the charge durations: 0.5 hour; 1 hour; 2 hour; 4 hour; 6 hour; 8 hours; 10 hours; 12 hours show that along with an increase of the level of the state of the capacitor's charge the capacitance grows and is 2,422.8 F; 2,448.4 F; 3,152.2 F; 5,264.5 F; 7,296.1 F; 9,067.4 F; 10,577.1 F; and 11,636.1 F, respectively.

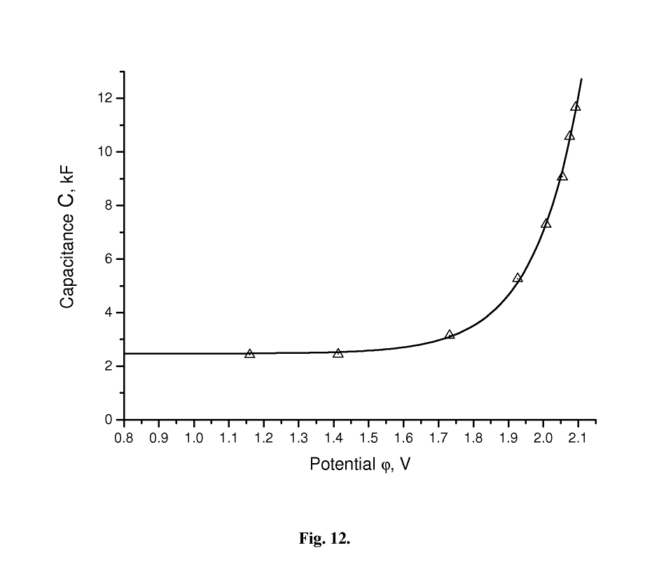

It follows from the obtained results that first the capacitance of the DEL of the carbon plate depends significantly on its potential at a high level of the capacitor's state of charge and along with an increase of the potential φ₋ (in relation to the potential of PbO₂/PbSO₄ reference electrode) the value of capacitance grows exponentially (FIG. 12). Secondly, the carbon plate based on porous carbon powder synthesized by the proposed method has a high value of the specific capacitance of DEL (1285 F/g and 790 F/cm³). It follows that use of such carbon plates in electrochemical capacitors will make it possible to manufacture capacitors with high specific energy and capacity parameters.

The value of |Z| impedance of HES #12 at the end of charge and at the end of discharge was 58 mOhm and 27 mOhm, respectively.

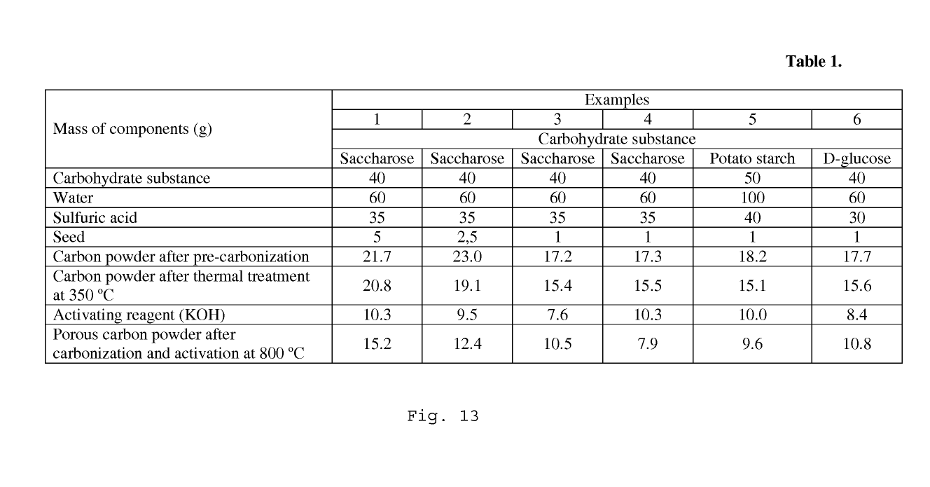

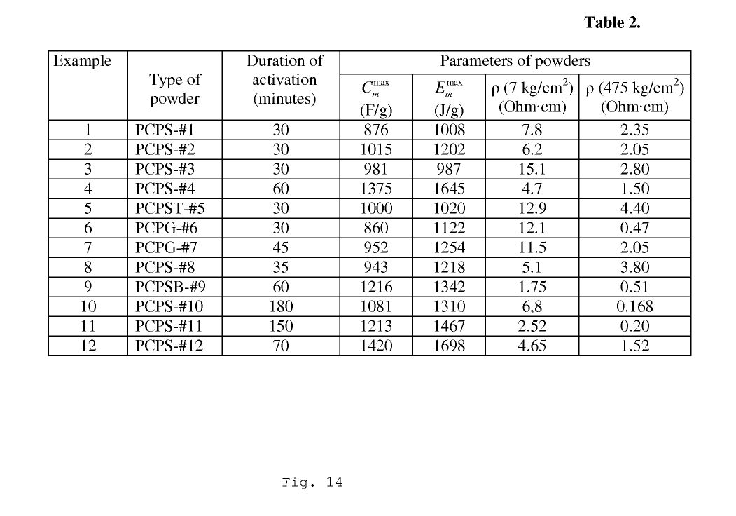

Table 1 of FIG. 13 lists the mass parameters of components during synthesis of exemplary porous carbon powders made of different carbohydrate substances. Table 2 of FIG. 14 lists the specific capacity, energy parameters and specific resistances of various exemplary porous carbon powders.

While certain embodiments of the present invention are described in detail above, the scope of the invention is not to be considered limited by such disclosure, and modifications are possible without departing from the spirit of the invention as evidenced by the following claims:

What is claimed is:

1. A method of synthesis of porous conductive carbon powder made of one or more carbohydrate organic phytogenous substances, comprising:
preliminarily initiating carbonization of a mixture of the organic substance(s) by exposure to a seed of carbon particles under normal conditions, the mixture consisting essentially of:
water,
at least one of the organic substances,
at least one dehydrating component, and
conductive carbon powder;
preliminarily initiating carbonization of the organic substance(s) of the mixture at elevated temperatures by thermal treatment of the mixture after the completion of exposure thereof to the seed of carbon particles under normal conditions;
causing interim carbonization at elevated temperatures by thermal treatment of the carbon powder obtained after preliminary carbonization;
causing final carbonization and parallel chemical activation of the carbon powder obtained after interim carbonization, or processes of final carbonization and gas-vapor activation of the carbon powder obtained after the interim carbonization or consequential processes of chemical and gas-vapor activation of carbon powder.

2. A method of claim 1 wherein, at least one substance from the group consisting of monosaccharides, disaccharides and polysaccharides, or their mixtures with different combinations and with different mass ratios of components is used as an organic carbohydrate substance.

3. A method of claim 2, wherein the monosaccharides have the molecular formula C₆H₁₂O₆, the disaccharides have the molecular formula C₁₂H₂₂O₁₁ and the polysaccharides have the molecular formula (C₆H₁₀O₅)ₙ, where n is a whole number between 2 and 15,000.

4. A method of claim 2, wherein the mass content of iron, manganese and ash in the monosaccharides, disaccharides and polysaccharides, when dry, is not more than 100 ppm, 200 ppm and 1.5% respectively.

5. A method of claim 1, wherein one or more organic substances selected from the group consisting of monosaccharides of not less than 50 mass % of dry substance, disaccharides of not less than 50 mass % of dry substance and polysaccharides of not less than 50 mass % of dry substance, or their mixtures with different combinations and with different mass ratios of the components, are used as an organic carbohydrate substance.

6. A method of claim 1, wherein the synthesis of carbon powder includes the preliminary carbonization of the carbohydrate substance(s), as initiated by a seed.

7. A method of claim 6, wherein an activated or non-activated, conductive, finely dispersed carbon powder(s) is used as a seed.

8. A method of claim 7, wherein the specific resistance of the finely dispersed activated and non-activated carbon powders is not more than 15 Ohm·cm and 10 Ohm·cm respectively, at a pressure of approximately 475 kg/cm².

9. A method of claim 6, wherein the preliminarily initiated carbonization is performed at a temperature of not higher than 50° C. for about 0.5 to 10 hours.

10. A method of claim 1, wherein the mass of the seed is selected as between about 0.1 to 30 mass % of the maximum mass of the carbon of the carbohydrate organic substance.

11. A method of claim 1, wherein the mixture is manufactured by mixing at least one type of organic substance and carbon seed with water, homogenizing the mixture, adding at least one type of dehydrating component to the resultant mixture, and further homogenizing the mixture.

12. A method of claim 11, wherein the dehydrating component removes the main part of the hydrogen and oxygen atoms from the molecules of the carbohydrate organic substance and is selected from the group consisting of sulfuric acid, phosphoric acid, nitric acid and different mixtures thereof.

13. A method of claim 1, wherein the synthesis of carbon powder includes a process of preliminary, seed-initiated carbonization of the one or more carbohydrate substances at an elevated temperature(s) of between about 120-180° C. for a duration of about 0.5 to 5 hours.

14. A method of claim 13, wherein after the preliminary carbonization of the one or more carbohydrate substances at an elevated temperature(s), the carbon powder is filtered, rinsed with water, and dried.

15. A method of claim 1, wherein the synthesis of the carbon powder includes interim carbonization in a vacuum or in the presence of a gas selected from the group consisting of nitrogen, argon, helium and various mixtures thereof, at a temperature(s) of between about 250-350° C. for a duration of about 1 to 3 hours.

16. A method of claim 1, wherein final carbonization and activation occurs at a temperature(s) of between about 600-1,000° C. for a duration of between about 20 minutes to 6 hours.

17. A method of claim 16, wherein chemical activation is by a reagent selected from the group consisting of KOH, LiOH, NaOH and ZnCl₂, or by the method of gas-vapor activation using a carbon dioxide reagent or superheated water vapor, or a combination of both methods.

18. A method of claim 16, wherein for the final carbonization and chemical activation of the carbon powder for the generation of pores, the carbon powder is mixed with at least one reagent selected from the group consisting of KOH, LiOH, NaOH, ZnCl₂, and combinations thereof, and carbonization is performed at a temperature(s) of between about 600-900° C. for between about 20 minutes to 2 hours

19. A method of claim 18, wherein the final carbonization and chemical activation is performed in a vacuum, or in a medium selected from the group consisting of gaseous nitrogen, argon and helium, and mixtures thereof.

20. A method of claim 18, wherein after the final carbonization and chemical activation of the carbon powder for generation of pores, the process of synthesis is completed by rinsing with water and drying.

21. A method of claim 20, wherein the capacitance of a double electric layer of the synthesized powder in aqueous and organic electrolytes depends on the potential of polarization, the specific capacitance of the double electric layer is between about 600-1,300 F/g, and the specific resistance has a value of not more than 15 Ohm·cm at a pressure of 475 kg/cm².

22. A method of claim 17, wherein the final carbonization of carbon powder is performed in a vacuum or in a medium of inert gas at a temperature(s) of between about 600-800° C. for between about 30 minutes-1.5 hours, and gas-vapor activation of the carbon powder is performed at a temperature(s) of between about 700-1,000° C. for between about 1-6 hours.

23. A method of claim 22, wherein the capacitance of a double electric layer of the synthesized powder in aqueous and organic electrolytes depends on the potential of polarization, the specific capacitance of the double electric layer is between about 700-1,400 F/g, and the specific resistance has a value of not more than 15 Ohm·cm at a pressure of 475 kg/cm².

24. A method of claim 1, wherein chemical and gas-vapor activation or gas-vapor and chemical activation of the carbon powder is performed after the process of synthesis of the porous carbon powder is complete.

25. A method of claim 24, wherein the capacitance of a double electric layer of the synthesized powder in aqueous and organic electrolytes depends on the potential of polarization, the specific capacitance of the double electric layer is between about 700-1,400 F/g, and the specific resistance has a value of not more than 20 Ohm·cm at a pressure of 475 kg/cm².

26. A method of synthesis of porous conductive carbon powder made of one or more carbohydrate organic phytogenous substances and doped by boron, comprising:
preliminarily initiating carbonization of a mixture of the organic substance(s) by exposure to a seed of carbon particles under normal conditions, the mixture consisting essentially of:
water,
at least one of the organic substances,
at least one dehydrating component,
conductive carbon powder, and
one or several types of soluble compounds of boron;
preliminarily initiating carbonization of the organic substance(s) of the mixture at elevated temperatures by thermal treatment of the mixture after the completion of exposure thereof to the seed of carbon particles under normal conditions;
causing interim carbonization at elevated temperatures by thermal treatment of the carbon powder obtained after preliminary carbonization;
causing final carbonization and parallel chemical activation of the carbon powder obtained after interim carbonization, or processes of final carbonization and gas-vapor activation of the carbon powder obtained after the interim carbonization or consequential processes of chemical and gas-vapor activation of carbon powder.

27. A method of claim 26, wherein at least one substance from the group consisting of monosaccharides, disaccharides and polysaccharides, or their mixtures with different combinations and with different mass ratios of components is used as an organic carbohydrate substance.

28. A method of claim 27, wherein the monosaccharides have the molecular formula C₆H₁₂O₆, the disaccharides have the molecular formula C₁₂H₂₂O₁₁ and the polysaccharides have the molecular formula (C₆H₁₀O₅)ₙ, where n is a whole number between 2 and 15,000.

29. A method of claim 26, wherein the boron used to dope the carbon powder is made of chemical compounds of boron, which are soluble in one or more substances selected from the group consisting of water, sulfuric acid, phosphoric acid and nitric acid.

30. A method of claim 29, wherein the chemical compounds of boron are reduced to the neutral boron by carbon or by carbon in the presence of nitrogen and/or carbon monoxide (CO) at a temperature of not higher than 1,000° C.

31. A method of claim 29, wherein the chemical compounds of boron are introduced into the mixture before the process of preliminary, seed-initiated carbonization.

32. A method of claim 31, wherein the at least one dehydrating component is selected from the group consisting of oxidizers, sulfuric acid, phosphoric acid, nitric acid and different mixtures thereof.

33. A method of claim 31, wherein preliminary carbonization is performed at a temperature of not higher than 50° C. for between about 0.5 to 10 hours.

34. A method of claim 31, further comprising a process of preliminary, seed-initiated carbonization of the carbohydrate substance(s) at an elevated temperature(s) of between about 120-180° C. for between about 0.5 to 5 hours.

35. A method of claim 26, wherein the synthesis of carbon powder includes preliminary, seed-initiated carbonization of the carbohydrate substance(s).

36. A method of claim 26, further comprising interim carbonization in a vacuum or in a medium of a gas selected from the group consisting of nitrogen, argon, helium and various mixtures thereof at a temperature(s) of between about 250-350° C. for between about 1-3 hours.

37. A method of claim 26, wherein final carbonization and activation after preliminary carbonization occurs at a temperature(s) of between about 900-1,000° C. for between about 20 minutes to 3 hours.

38. A method of claim 37, wherein chemical activation is by a reagent selected from the group consisting of KOH, LiOH, NaOH and ZnCl₂, or by the method of gas-vapor activation using a carbon dioxide reagent or superheated water vapor.

39. A method of claim 38, wherein the final carbonization and chemical activation of the carbon powder for the generation of pores is performed in a vacuum or in a medium selected from the group consisting of gaseous nitrogen, argon and helium, and mixtures thereof.

40. A method of claim 39, wherein the synthesis process is complete after chemical and gas-vapor activation.

41. A method of claim 40, wherein the content of boron in the synthesized porous carbon powder is in the range of between about 0.1-2 atomic %.

42. A method of claim 40, wherein the capacitance of a double electric layer of the synthesized powder in aqueous and organic electrolytes depends on the potential of polarization, the specific capacitance of the double electric layer is between about 900-1,400 F/g, and the specific resistance has a value of not more than 5 Ohm·cm at a pressure of 475 kg/cm².
